(19) United States
(12) Patent Application Publication
(10) Pub. No.: US 2026/0366999 A1
(43) Pub. Date: Nov. 19, 2026

(54) High Repetition Rate Transient Transmission Spectroscopy

(71) Applicant: The Board of Trustees of the University of Illinois, Urbana, IL (US)

(72) Inventors: Stephan Link, Champaign, IL (US); Subhasis Adhikari, Urbana, IL (US); Niklas Gross, Manvel, TX (US)

(21) Appl. No.: 19/677,223

(22) Filed: May 14, 2026

Related U.S. Application Data
(60) Provisional application No. 63/806,474, filed on May 15, 2025.

(51) Int. Cl. G01N 21/63; B82Y 35/00

(52) U.S. Cl. CPC G01N 21/636; B82Y 35/00; G01N 2201/06113; G01N 2201/0686; G01N 2201/0691

(57) ABSTRACT

The disclosure relates to transient transmission spectroscopy. One example embodiment includes a system. The system includes a pump source configured to supply a pump signal having an excitation wavelength. The system also includes a modulator configured to modulate the pump signal according to a modulation frequency. The pump signal is configured to excite at least one nanoparticle at the excitation wavelength. Additionally, the system includes a probe source configured to supply a probe signal to the at least one nanoparticle. A measurement signal is generated when the probe signal interacts with the at least one nanoparticle. Further, the system includes a lock-in camera that includes an image sensor having a plurality of pixels and a transmission grating configured to spectrally disperse the measurement signal across the plurality of pixels. The lock-in camera is configured to lock-in to the modulation frequency and detect the spectrally dispersed measurement signal.

### CROSS-REFERENCE TO RELATED APPLICATIONS

This application claims priority to U.S. Provisional Patent Application No. 63/806,474, filed May 15, 2025, the contents of which are incorporated by reference in its entirety.

### STATEMENT REGARDING FEDERALLY SPONSORED RESEARCH OR DEVELOPMENT

This invention was made with government support under contract numbers CHE-2413590 and DMR-2225592 awarded by the National Science Foundation. The government has certain rights in the invention.

### BACKGROUND

Nanoparticles are small particles of matter, such as those, between 1 nanometer (nm) and 100 nm in diameter. These nanoparticles may be relevant across many technological fields (e.g., geology, chemistry, biology) and prevalent in many products (e.g., ceramics, paints, etc.). For example, time-resolved spectroscopy of plasmonic nanoparticles may facilitate probing ultrafast electron dynamics and both subsequent acoustic and photothermal properties.

Since nanoparticles may have diameters smaller than the wavelengths of visible light, imaging and characterization of nanoparticles, either individually or as part of an ensemble, may be difficult. For example, making measurements of plasmonic nanoparticles using spectrally broad probe beams on the ensemble level to achieve high signal amplitudes may be challenging because the relaxation dynamics of plasmonic nanoparticles may depend on their size, shape, and crystallinity. As such, the inherent heterogeneity of most nanoparticle samples may complicate efforts to build microscopic models for these dynamics based solely on ensemble measurements. As a result, some techniques for measuring nanoparticles may be limited in their ability to capture electronic dynamics and acoustic vibrations of nanoparticles over a broad range of wavelengths.

### SUMMARY

The specification and drawings disclose embodiments that relate to transient transmission spectroscopy. According to the techniques described herein, a modulated pump signal is used in combination with a probe signal (e.g., a broad-spectrum probe signal) to characterize nanoparticles and molecules, individually and/or as part of an ensemble. The techniques described herein include making measurements using a lock-in camera that locks-in to the modulated frequency of the pump signal and records a measurement signal (e.g., a broad-spectrum measurement signal) resulting from the interaction between the probe signal and the nanoparticle(s). Example embodiments facilitate simultaneous measurements across multiple wavelengths, which may provide the ability to characterize multiple disparate physical phenomena associated with nanoparticle(s) using a single capture by the lock-in camera.

In a first aspect, the disclosure describes a system. The system includes a pump source configured to supply a pump signal having an excitation wavelength. The system also includes a modulator configured to modulate the pump signal according to a modulation frequency. The pump signal is configured to excite at least one nanoparticle at the excitation wavelength. Additionally, the system includes a probe source configured to supply a probe signal to the at least one nanoparticle. A measurement signal is generated when the probe signal interacts with the at least one nanoparticle when the at least one nanoparticle is excited at the excitation wavelength. Further, the system includes a lock-in camera that includes an image sensor having a plurality of pixels. In addition, the system includes a transmission grating configured to spectrally disperse the measurement signal across the plurality of pixels of the lock-in camera. The lock-in camera is configured to lock-in to the modulation frequency and detect the spectrally dispersed measurement signal.

In a second aspect, the disclosure describes a method. The method includes modulating a pump signal according to a modulation frequency to produce a modulated pump signal. The modulated pump signal includes an excitation wavelength. The method also includes exciting, with the modulated pump signal, at least one nanoparticle to produce at least one excited nanoparticle. Further, the method includes interacting a probe signal with the at least one excited nanoparticle to produce a measurement signal. Moreover, the method includes dispersing, spectrally, the measurement signal across a plurality of pixels of a lock-in camera to produce a spectrally dispersed measurement signal. In addition, the method includes detecting, by the lock-in camera, the spectrally dispersed measurement signal.

In a third aspect, the disclosure describes a non-transitory, computer-readable medium, having stored thereon program code that, when executed by a processor, causes the processor to perform operations. The operations include modulating a pump signal according to a modulation frequency to produce a modulated pump signal. The modulated pump signal includes an excitation wavelength. The operations also include exciting, with the modulated pump signal, at least one nanoparticle to produce at least one excited nanoparticle. Further, the operations include interacting a probe signal with the at least one excited nanoparticle to produce a measurement signal. Moreover, the operations include dispersing, spectrally, the measurement signal across a plurality of pixels of a lock-in camera to produce a spectrally dispersed measurement signal. In addition, the operations include detecting, by the lock-in camera, the spectrally dispersed measurement signal.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a schematic diagram of a system, according to example embodiments.

FIG. 2 is a transient transmission image, according to example embodiments.

FIG. 3A is an illustration of a magnified image of a single 120 nm gold nanodisk (AuND) and corresponding line profile, according to example embodiments.

FIG. 3B is an illustration of an image of a 120 nm AuND and corresponding line profile, according to example embodiments.

FIG. 4A is a graph of a spectrum of an 800 nm probe, according to example embodiments.

FIG. 4B is a graph of a spectrum of a white light continuum probe, according to example embodiments.

FIG. 5 is a graph of dark-field scattering (DFS) spectrum of a 140 nm AuND with its corresponding scanning electron microscope (SEM) image, according to example embodiments.

FIG. 6 is a graph of time-dependent transient transmission traces, according to example embodiments.

FIG. 7 is a graph of an acoustic oscillation signal, according to example embodiments.

FIG. 8 is an image of transient transmission spectra, according to example embodiments.

FIG. 9 is a graph of a transient transmission and corresponding power spectrum, according to example embodiments.

FIG. 10 is a graph of an acoustic oscillation signal, according to example embodiments.

FIG. 11 is a graph of time-resolved transient transmission traces, according to example embodiments.

FIG. 12 is a graph of a transient transmission spectrum, according to example embodiments.

FIG. 13 is a graph of acoustic oscillations and best fit lines, according to example embodiments.

FIG. 14 is a graph of short-time ultrafast transient dynamics, according to example embodiments.

FIG. 15 illustrates graphs of measurements of the beam size for a 400 nm beam, according to example embodiments.

FIG. 16 illustrates graphs of measurements of the beam size for a 600 nm beam, according to example embodiments.

FIG. 17 illustrates graphs of measurements of the beam size for a 700 nm beam, according to example embodiments.

FIG. 18 illustrates graphs of measurements of the beam size for a 550 nm beam, according to example embodiments.

FIG. 19 illustrates graphs of measurements of the beam size for a 650 nm beam, according to example embodiments.

FIG. 20 illustrates graphs of measurements of the beam size for a 750 nm beam, according to example embodiments.

FIG. 21 illustrates a graph of wavelength calibration measurements, according to example embodiments.

FIG. 22 illustrates a graph of probe beam chirp correction measurements, according to example embodiments.

FIG. 23 is a graph of the DFS spectrum of a 120 nm AuND, according to example embodiments.

FIG. 24 illustrates a graph of a transient transmission and corresponding power spectrum, according to example embodiments.

FIG. 25 illustrates phase measurements of a single 120 nm AuND at different probe wavelengths, according to example embodiments.

FIG. 26 is a flowchart illustration of a method, according to example embodiments.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the figures should not be viewed as limiting. It should be understood that other embodiments might include more or less of each element shown in a given figure. In addition, some of the illustrated elements may be combined or omitted. Similarly, an example embodiment may include elements that are not illustrated in the figures.

### I. OVERVIEW

Single-particle spectroscopy may be used for mechanistic studies of the optical properties of metallic and semiconducting nanomaterials. By measuring individual particles, the dependence of optical behavior on the distinct physical properties of each particle may be considered, thereby reducing spectral broadening and other effects that stem from heterogeneity within a nanoparticle ensemble. Steady-state, single-particle techniques may be used to obtain spectral information regarding the absorption, scattering, emission, and extinction of light by nanomaterials, such as plasmonic nanoparticles, carbon nanomaterials, and quantum dots. The insights gained may make nanomaterials promising for many applications in diverse areas, such as catalysis, sensing, and photothermal therapy.

Beyond the steady-state regime, time-resolved studies may facilitate understanding of the underlying mechanisms that govern the optical properties of these nanomaterials. By tracking the optical behavior down to the femtosecond (fs) timescale after initial photoexcitation, time-resolved methods may resolve the ultrafast dynamics of photoexcited charge carriers, such as their equilibration and diffusion, and subsequent mechanical and thermal effects. Time-resolved methods, such as transient absorption/extinction spectroscopy and 2D ultrafast spectroscopy, may involve the use of laser pulses to pump and probe samples with adjustable time delays between them. On the ensemble level, these techniques may provide a wealth of information on systems ranging from biological materials to organic crystals and nanoparticles. Measurements of single particles may facilitate resolution of photoexcited dynamics when the material's properties are affected by heterogeneity in particle morphology or local environment.

Time-resolved spectroscopy of individual nanoparticles may be challenging due to the difficulty of obtaining sufficient signal levels across a range of probe wavelengths. To perform time-resolved measurements of nanoparticle ensembles, femtosecond laser sources (e.g., with repetition rates in the kHz regime) may be used to generate excitation pulses via optical parametric amplification and spectrally broad probe pulses via supercontinuum generation. These pulses may be loosely focused on spots of a few hundred microns to reduce photo-damage. Pump induced changes in the transmission of the probe pulse may be detected using a charge-coupled device (CCD) and/or complementary metal-oxide-semiconductor (CMOS) detector coupled to a spectrometer. In contrast, time-resolved measurements of single particles may involve focusing the pump and probe pulses to diffraction-limited spots using microscope objectives to increase signal amplitude. Despite this tight focus, these signal levels may be too small to be detectable using certain cameras. To address this issue, detection of pump-probe signals may be performed using pre-amplifying photodiodes and/or photomultipliers in combination with lock-in amplification to extract small signals from the much larger background. Use of high repetition rate (e.g., greater than 1 MHz) lasers may boost this detection scheme by facilitating improved signal averaging while employing low-power pulses that may reduce the risk of sample photodamage.

Such detection schemes may involve reduced areas of spectral detection as single photodiodes may capture a single probe wavelength at a time. Further, spectral information for single nanoparticles may involve collection of multiple measurements at different, individual wavelengths in a sequential manner. This may mean that data collection via this scheme may be time-consuming and may be impacted by fluctuations in the spectral profile of the probe source.

To help address such issues, as described herein, a pixel-array lock-in camera may be integrated into a time-resolved transient transmission microscope. Such a configuration may be used to measure the transient transmission spectrum of an individual gold nanodisk (AuND) in a single measurement. Each pixel of the lock-in camera may behave similarly to a photodiode coupled to a lock-in amplifier, facilitating high-sensitivity detection of the transient extinction signal for a spectrally dispersed probe beam. Such a pixel-array lock-in camera may be used to interrogate bulk materials, such as thin films of polymers, perovskites, metal organic frameworks, carbon materials ranging from graphene to diamond, single objects including nano- and micro-particles, polymers, and small molecules. A lock-in camera may measure the transient transmission signal of a single AuND, and these measurements may be compared to measurements performed on the same AuND using other photodiode detection methods. The techniques described herein may yield a time-resolved transient spectrum for a single AuND in one measurement, thereby facilitating measurement of both the electronic dynamics and acoustic vibrations of the AuND at different wavelengths simultaneously.

Example embodiments herein provide arrangements for simultaneously characterizing nanoparticles across a spectrum of wavelengths (e.g., a spectrum of probe wavelengths). This may enable improved efficiency when characterizing nanoparticles when compared with techniques that involve multiple measurements in order to capture multiple wavelengths.

The techniques described herein may be performed by a time-resolved transient transmission microscope with a pixel-array lock-in camera integrated therein. Each pixel of the lock-in camera may behave in a similar fashion to a photodiode coupled to a lock-in amplifier. As such, techniques described herein may provide high-sensitivity detection of transient extinction signals for a spectrally dispersed probe beam.

Time-resolved microscopy signals may be collected from individual nanoparticles at selected probe wavelengths. Acquiring time-resolved spectra from single objects may be challenging. The techniques described herein may facilitate the efficient yield of time-resolved spectra of a single gold nanodisk in one measurement. This may be facilitated by modulating the frequency-doubled output of a 96-megahertz (MHz) titanium-sapphire (Ti:Sapphire) oscillator at 8-kilohertz (kHz). Such modulation may facilitate the use of a lock-in pixel-array camera to detect photo-induced changes in the transmission of a white light continuum probe derived from a photonic crystal fiber to produce broadband femtosecond transmission spectra of a single gold nanodisk. The performance of the lock-in camera may be compared for the same single nanoparticle to detection with a single-element photodiode and may indicate comparable sensitivities. The lock-in camera may, thus, provide an advantage due to its ability to multiplex spectral detection, which may be utilized to capture both the electronic dynamics and acoustic vibrations of a single gold nanodisk following ultrafast laser excitation.

### II. EXAMPLE SYSTEMS

The following description and accompanying drawings will elucidate features of various example embodiments. The embodiments provided are by way of example and are not intended to be limiting. As such, the dimensions of the drawings are not necessarily to scale.

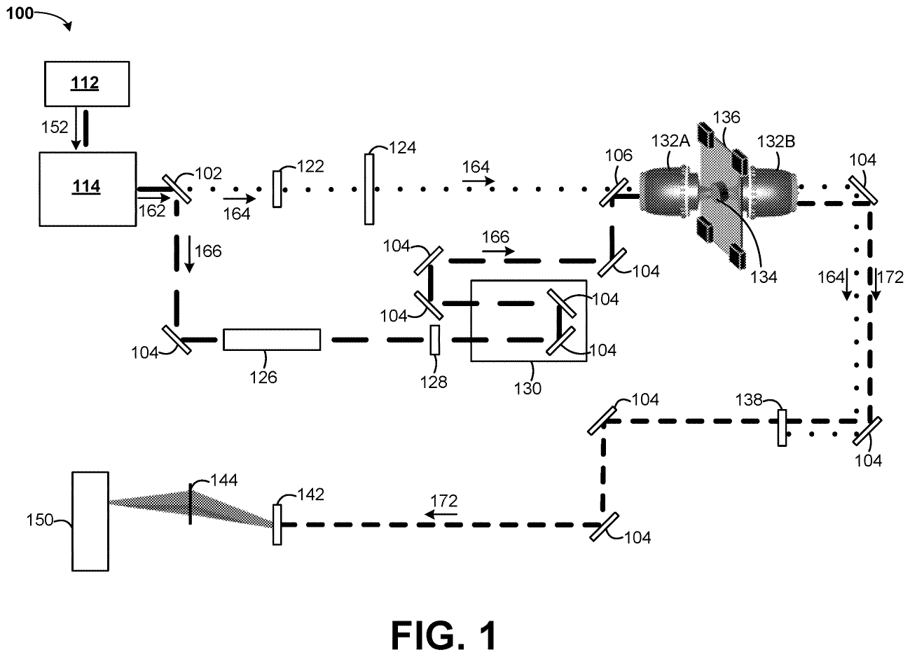

FIG. 1 is a schematic diagram of a system 100, according to example embodiments.

The system 100 may be configured to measure and/or characterize at least one nanoparticle 134 (e.g., an AuND). While various example embodiments described herein may include AuNDs, it will be understood that the at least one nanoparticle 134 could include one or more of: a plasmonic material (e.g., silver, copper), a semiconductor material (e.g., quantum dots), and/or a two-dimensional material (e.g., graphene, transition metal dichalcogenides), molecules including biopolymers (e.g., deoxyribonucleic acid (DNA), ribonucleic acid (RNA), proteins), and bulk materials (e.g., thin films of polymers, perovskites and metal organic frameworks). Other materials and material systems are possible and contemplated.

The at least one nanoparticle 134 may be formed as follows. Two-by-two (2×2) arrays of AuNDs with diameters of 120 nanometers (nm) and 140 nm, a thickness of 35 nm, and an interparticle distance of 10 microns (μm) may be fabricated using electron beam lithography (EBL) on glass. A 25×25×0.17 millimeter (mm) glass substrate (e.g., CORNING®, Product Number 2850-25) may be cleaned by washing in an ultrasonic bath with a 2% (v/v) HELLMANEX™ detergent, 200 proof ethanol, and ultrapure water for 10 minutes each. The substrates may be dried under a stream of nitrogen and plasma etched with oxygen for 2 minutes. The substrates may be spin-coated at 4,000 revolutions per minute (rpm) for 1 minute with 950 poly (methyl methacrylate) A4 (KAYAKU ADVANCED MATERIALS®), followed by a 2-minute bake on a 180 °C hotplate. Coverslips may be spin-coated with the conductive polymer ESPACER™ 300Z (SHOWA DENKO®) at 3,000 rpm for 1 minute and may be taken to an ELIONIX® ELS-G100 electron beam writer operating at 100 kilovolts (kV) and 1 nanoampere (nA). The patterns may be developed by immersion for 65 seconds (s) in a 1:3 (volume per volume) solution of methyl isobutyl ketone to isopropyl alcohol (MIBK:IPA) and may be rinsed in IPA before being blown dry with nitrogen. Metal layers may be deposited at a rate of 0.3 angstroms per second (Å/s) using an electron beam evaporator and may be started with a 2 nm Ti adhesion layer, followed by a 35 nm Au deposition. Excess Au and Ti may be removed by soaking the samples in acetone for 72 hours, sonicating, and drying under a nitrogen stream.

The AuND arrays may be characterized by scanning electron microscopy (SEM) on an FEI® QUANTA® 400 field emission gun (FEG) environmental scanning electron microscope (ESEM) using a dwell time of 10 microseconds (μs) and a voltage of 15 kilovolts (kV). Due to the non-conductive nature of the glass substrates, all images may be measured under environmental conditions in a water atmosphere at approximately 4×10⁻⁴ torr.

The system 100 may include a continuous-wave laser 112, a common oscillator 114, a pump source 122, a modulator 124, a probe source 126, one or more of microscope objectives 132A, 132B, a sample stage 136, a lock-in camera 150, and one or more free-space optics (e.g., a beamsplitter 102, one or more mirrors 104, a dichroic mirror 106, a band-pass filter 128, a delay stage 130, a low-pass filter 138, a transmission grating 142, and a lens 144). Further, additional free-space optics and/or alternative locations of free-space optics not illustrated in FIG. 1 may also be included in the system 100, in some embodiments. As illustrated, the components of the system 100 may transmit and receive one or more optical signals from one another as well as modify the optical signal(s). The arrows indicated above, next to, or as part of the components of the system 100 indicate a direction of transmission of the one or more signals.

As illustrated in FIG. 1, the continuous-wave laser 112 may emit an oscillator-pumping signal 152 that is supplied to the common oscillator 114. In some embodiments, the oscillator-pumping signal 152 may have a power between 7 W and 10 W (e.g., 8 W) and/or a center wavelength between 528 nm and 536 nm (e.g., 532 nm). In some embodiments, the continuous-wave laser 112 may include a high-power, continuous-wave laser (e.g., COHERENT® VERDI® G10). In some embodiments, the oscillator-pumping signal 152 may have a repetition rate between 10 MHz and 150 MHz. In some embodiments, a higher repetition rate may improve the performance of (e.g., detection by) a lock-in camera 150.

The common oscillator 114 may receive the oscillator-pumping signal 152 from the continuous-wave laser 112. The common oscillator 114 may generate an output based on the oscillator-pumping signal 152 that is fed to both the pump source 122 and the probe source 126. In some embodiments, the common oscillator 114 may include either a Ti:sapphire oscillator (e.g., a KMLABS® GRIFFIN™-10) or a ultrafast laser source without external pumping source 112 configured to produce pulses 162 (e.g., that are supplied to both the pump source 122 and the probe source 126) with a repetition rate between 10 MHz and 150 MHz (e.g., 96 MHz). Additionally, the produced pulses 162 may have a pulse width between 10 fs and 10 ps (e.g., 100 fs). Further, the produced pulses 162 may have a center wavelength between 700 nm and 1,600 nm (e.g., 800 nm). As illustrated, the produced pulses 162 may be split between the pump source 122 and the probe source 126 using the beamsplitter 102.

The pump source 122 may be configured to supply a pump signal 164 at an excitation wavelength (e.g., an excitation wavelength configured to excite the at least one nanoparticle 134) based on the received portion of the produced pulses 162. In some embodiments, the pump source 122 may include a frequency doubler. For example, the pump source 122 may include a beta barium borate crystal (e.g., ALTOS BBO-1004H). Additionally or alternatively, the pump signal 164 generated by the pump source 122 may have a center wavelength between 350 nm and 1,600 nm (e.g., 400 nm). Upon generation by the pump source 122, the pump signal 164 may be provided to the modulator 124.

In embodiments where the at least one nanoparticle 134 is an AuND, the excitation wavelength may be approximately 400 nm to excite Au interband transitions. In other embodiments, the excitation wavelength may be between 300 nm and 1,600 nm.

In some embodiments, the pump source 122 may include a photonic fiber. Doing so may facilitate dynamic adjustment to the frequency of the pump signal 164.

The modulator 124 may be configured to modulate the pump signal 164 according to a modulation frequency. Upon modulation, the pump signal 164 may be provided to the dichroic mirror 106 to be aligned with a probe signal 166 and/or aligned to the at least one nanoparticle 134. In some embodiments, the modulation frequency may be between 2 kHz and 250 kHz (e.g., 8 kHz). In some embodiments, the modulation frequency may be adjusted based on the properties of the lock-in camera 150. Additionally or alternatively, in some embodiments, the modulator 124 may include a mechanical optical chopper, an acousto-optic modulator, and/or a tunable crystal filter. For example, the modulator 124 may include a phase locked optical chopper with six chopper wheels (e.g., NEWPORT® model 3502).

In some embodiments, the portion of the produced pulses 162 that is sent to the probe source 126 may be reflected by a mirror 104 prior to reaching the probe source 126, as illustrated. The probe source 126 may be configured to generate a probe signal 166 that is subsequently provided to the at least one nanoparticle 134. In some embodiments, the probe source 126 may include a non-linear photonic crystal fiber (e.g., NKT PHOTONICS FEMTOWHITE 800) configured to produce a probe signal 166 spanning multiple wavelengths (e.g., a broad-spectrum probe signal). For example, the probe signal 166 may include a white light continuum signal that has a range of wavelengths starting around 550 nm for the highest pump powers and extending up to, for example, 1,600 nm.

In some embodiments, the upper wavelength detection limit of the lock-in camera 150 may be a few microns (e.g., using indium gallium arsenide (InGaAs)-based detection).

In some embodiments, the probe source 126 may include a laser configured to produce a white light continuum signal that has a range of wavelengths starting around 550 nm for the highest pump powers and extending beyond the upper wavelength detection limit of the lock-in camera 150 (e.g., 1,600 nm).

Upon being generated by the probe source 126, the probe signal 166 may be propagated to the dichroic mirror 106 to be reunited with the pump signal 164. As illustrated, propagating the probe signal 166 to the dichroic mirror 106 may include reflecting the probe signal 166 off of one or more mirrors 104, passing the probe signal 166 through the band-pass filter 128 (and/or one or more short-pass filters), and/or passing the probe signal 166 through the delay stage 130 (e.g., which itself may include reflecting the probe signal 166 from one or more mirrors 104).

In some embodiments, the delay stage 130 may be configured to adjust the distance between the probe source 126 and the at least one nanoparticle 134 (e.g., the temporal overlap between the probe signal 166 and the pump signal 164). For example, when the delay stage 130 is in a first configuration, the probe signal 166 and the pump signal 164 may interact with the at least one nanoparticle 134 at the same time. As another example, when the delay stage 130 is in a second configuration, the pump signal 164 may interact with the at least one nanoparticle 134 before the probe signal 166 interacts with the at least one nanoparticle 134. As further example, when the delay stage 130 is in a third configuration, the pump signal 164 may interact with the at least one nanoparticle 134 after the probe signal 166 interacts with the at least one nanoparticle 134. In some embodiments, the delay stage may include a NEWPORT® UTS150CC.

In some embodiments, the delay stage 130 may include a mirror, the movement of which may control the time delay between pump signal 164 and probe signal 166.

In some embodiments, the band-pass filter 128 may be configured to narrow the range of wavelengths of the probe signal 166 (e.g., from between 400 nm and 1,700 nm to between 550 nm and 552 nm). In some embodiments, the probe signal 166 may include a fundamental beam (e.g., a beam with a wavelength of 800 nm or 1,070 nm). Such a fundamental beam may have high intensity stability.

In some embodiments, the probe source 126 may be configured to modify the probe signal 166 such that the probe signal 166 has a narrow range of wavelengths. In such embodiments, the band-pass filter 128 may be removed. Doing so may reduce the cost of producing system 100 and/or reduce energy loss through absorption by the band-pass filter 128.

In some embodiments, the probe signal 166 and the pump signal 164 may be reunited at the dichroic mirror 106 (e.g., aligned axially by the dichroic mirror 106). Once the probe signal 166 and the pump signal 164 have been reunited at the dichroic mirror 106, both the probe signal 166 and the pump signal 164 may be focused onto the at least one nanoparticle 134 (e.g., via an upstream microscope objective 132A). Such a focusing may result in the focused pump signal having an enhanced intensity relative to the pump signal 164 and the focused probe signal having an enhanced intensity relative to the probe signal 166. In some embodiments, the upstream microscope objective 132A may be configured to focus both the pump signal 164 and the probe signal 166 to the diffraction limit on the at least one nanoparticle 134. Further, the sample stage 136 (e.g., a piezo-electric stage) may be configured to adjust the position of the at least one nanoparticle 134 relative to the probe signal 166 and the pump signal 164. Additionally or alternatively, the upstream microscope objective 132A may include an objective with a numerical aperture between 0.1 and 1.4 (e.g., ZEISS® PLAN-APOCHROMAT 63×, 1.4NA). Further, the upstream microscope objective 132A may be a portion of a ZEISS® microscope (e.g., AXIO® Observer m1). In some embodiments, a widefield lens may replace the microscope objective for a larger area (e.g., 250 μm) wide-field illumination.

In some embodiments, at the at least one nanoparticle 134, the pump signal 164 may have an energy density of between 1×10³ Watts per square centimeter (W/cm²) and 1×10⁵ W/cm² (e.g., 4.38×10⁴ W/cm²). In some embodiments, at the at least one nanoparticle 134, the probe signal 166 may have an energy density of between 1×10³ W/cm² and 1×10⁵ W/cm² (e.g., 1.4×10⁴ W/cm²). In embodiments where the probe signal 166 includes the fundamental beam, at the at least one nanoparticle 134, the fundamental beam may have an energy density of between 1.0×10³ W/cm² and 1.0×10⁵ W/cm² (e.g., 7.0×10⁴ W/cm²). In some embodiments, the pump signal 164, the probe signal 166, and/or the fundamental beam may have a beam size between 200 nm and 250 μm (e.g., between 250 nm and 500 nm), as measured by the knife-edge method.

In some embodiments, the probe signal 166 may interact with the at least one nanoparticle 134 after the pump signal 164 has excited the at least one nanoparticle 134 at the excitation wavelength. In such embodiments, the interaction between the probe signal 166 and the at least one nanoparticle 134 may generate a measurement signal 172 (e.g., a broad-spectrum measurement signal). The measurement signal 172 and the pump signal 164 may be collected optically downstream of the at least one nanoparticle 134 by a downstream microscope objective 132B. The downstream microscope objective 132B may include a receiving objective in a transmission geometry (e.g., ZEISS® LD ACHROPLAN 40×, 0.6 NA). In some embodiments, the NA of the objective may be within the range from 0.1 to 1.4. In some embodiments, a lens may replace one or more of microscope objectives 132A, 132B for the transmission signal.

In some embodiments, the system 100 may include more than one of the upstream microscope objective 132A and/or the downstream microscope objective 132B. The use of more than one the upstream microscope objective 132A and/or the downstream microscope objective 132B may allow greater flexibility in the probe volume, which may facilitate determining the properties of bulk samples and/or solutions.

In some embodiments, the measurement signal 172 and the pump signal 164 may leave the downstream microscope objective 132B and propagate to the transmission grating 142 (e.g., which may include being reflected by one or more mirrors 104). In some embodiments, prior to reaching the transmission grating 142, the pump signal 164 may be attenuated by a filter 138 (e.g., a long-pass filter).

In FIG. 1, the measurement signal 172, the probe signal 166, and the pump signal 164 are represented as spatially displaced. This is for the purposes of visualization and should not be understood as limiting the system 100. For example, the measurement signal 172 and the probe signal 166 may overlap spatially upon leaving the downstream microscope objective 132B.

In some embodiments, the measurement signal 172 may be spectrally dispersed (e.g., split by wavelength) by the transmission grating 142. The spectrally dispersed measurement signal 172 may be provided to an image sensor having a plurality of pixels of the lock-in camera 150 (e.g., via the lens 144 configured to focus the measurement signal 172 onto the plurality of pixels of the lock-in camera 150). In some embodiments, the lock-in camera 150 may be configured to lock-in to the modulation frequency generated by the modulator 124 and to detect the spectrally dispersed measurement signal 172. In some embodiments, each pixel of the lock-in camera 150 may be configured to perform lock-in amplification. Such amplification may increase the sensitivity of the lock-in camera 150.

In some embodiments, the transmission grating 142 may be replaced with one or more prisms and/or a reflective grating configured to disperse wavelengths of the measurement signal 172 across pixels of the lock-in camera 150 such that each pixel of the lock-in camera is associated with a range of wavelengths of the measurement signal 172. For example, when the lock-in camera includes 400 pixels, each of these pixels may be associated with a different range of wavelengths. In some embodiments, this range of wavelengths may define the resolution of the lock-in camera 150. For example, a first pixel of the lock-in camera 150 may be associated with a range of wavelengths between 500 nm and 501 nm and a second pixel of the lock-in camera 150 may be associated with a range of wavelengths between 501 nm and 502 nm (e.g., the lock-in camera 150 may have a spectral resolution of 1 nm).

In some embodiments, the at least one nanoparticle 134 may be visualized in transient transmission images by raster-scanning the sample with a piezo nanopositioning stage (e.g., Physik Instrumente P-517.3CL), while spatially and temporally overlapping the confocal pump signal 164 and probe signal 166.

In some embodiments, the transmission grating 142 may have a groove density of between 150 grooves/mm and 1,200 grooves/mm (e.g., 300 grooves/mm). In some embodiments, each groove may correspond with a range of wavelengths. Further, the transmission grating 142 may have a blaze angle of between 8.6° and 36.9° (e.g., 17.5°).

In some embodiments, the plurality of pixels of the lock-in camera 150 may be arranged in a square pixel array. For example, each side of the square pixel array may be between 275 pixels and 2048 pixels (e.g., a 300×300-pixel array).

In some embodiments, the lock-in camera 150 may include an analog-to-digital converter configured to output a digital signal based on the detected spectrally dispersed measurement signal 172. Upon detection by the lock-in camera 150, the spectrally dispersed measurement signal 172 may be used to characterize the at least one nanoparticle 134.

In some embodiments, detection may be alternated for the same nanoparticle (e.g., an AuND) between a single-element photodiode and the lock-in camera 150.

In some embodiments, the lock-in camera 150 may include an imaging spectrograph (e.g., TELEDYNE PRINCETON INSTRUMENTS® Acton SPECTRAPRO® 2150i). Further, the lock-in camera 150 may include a thermoelectrically cooled back-illuminated charge-coupled device (CCD) camera (e.g., TELEDYNE PRINCETON INSTRUMENTS® PIXIS® 400BR) mounted on a linear translation stage to record scattering spectra of multiple nanoparticles in a hyperspectral configuration.

In some embodiments, the system 100 may include a common oscillator 114 configured to feed both the pump source and the probe source.

In some embodiments, the common oscillator 114 may include a Ti:sapphire oscillator that may be configured to produce pulses with a repetition rate between 10 MHz and 150 MHz. In some embodiments, the pulses may have a pulse width between 10 fs and 10 ps. In some embodiments, the pulses may have a center wavelength between 700 nm and 1,600 nm.

In some embodiments, the system 100 may include a continuous-wave laser 112 configured to pump the common oscillator 114. In some embodiments, the continuous-wave laser 112 is configured to generate an oscillator-pumping signal 152. In some embodiments, the oscillator-pumping signal 152 has a power between 7 W and 10 W and a center wavelength between 528 nm and 536 nm.

In some embodiments, the at least one nanoparticle 134 may include a gold nanodisk. In some embodiments, the pump signal 164 may have a center wavelength between 350 nm and 1,600 nm. In some embodiments, the pump source 122 may include a beta barium borate crystal.

In some embodiments, the probe source 126 may include a non-linear photonic crystal fiber.

In some embodiments, the probe signal 166 may include light spanning wavelengths from a first wavelength to a second wavelength. In some embodiments, the first wavelength may be between 525 nm and 575 nm. In some embodiments, the second wavelength may be between 760 nm and 1,260 nm.

In some embodiments, the probe source 126 may include a short-pass filter configured to attenuate light having wavelengths above the second wavelength.

In some embodiments, the modulator 124 may include a mechanical optical chopper.

In some embodiments, the modulation frequency may be between 2 kHz and 250 kHz.

In some embodiments, the system 100 may include an upstream microscope objective 132A configured to focus the pump signal 164 and the probe signal 166 on the at least one nanoparticle 134. In some embodiments, the focused pump signal may have enhanced intensity relative to the pump signal 164. In some embodiments, the focused probe signal may have enhanced intensity relative to the probe signal 166.

In some embodiments, the upstream microscope objective 132A may be configured to focus the pump signal 164 and the probe signal 166 to a diffraction limit on the at least one nanoparticle 134.

In some embodiments, the upstream microscope objective 132A may include an objective. In some embodiments, a numerical aperture of the upstream microscope objective 132A may be between 0.1 and 1.4.

In some embodiments, the system 100 may include a dichroic mirror 106 configured to align the pump signal 164 and the probe signal 166 with one another prior to the pump signal 164 and the probe signal 166 arriving at the at least one nanoparticle 134.

In some embodiments, the system 100 may include a low-pass filter configured to attenuate the pump signal 164 after the pump signal 164 has excited the at least one nanoparticle 134 and prior to the pump signal 164 reaching the lock-in camera 150.

In some embodiments, the system 100 may include a lens 144 configured to focus the measurement signal 172 onto the plurality of pixels of the lock-in camera 150.

In some embodiments, the transmission grating 142 may include a groove density of between 150 groves/mm and 1,200 groves/mm. In some embodiments, the transmission grating 142 may have a blaze angle between 8.6° and 36.9°.

In some embodiments, the plurality of pixels may be arranged in a square pixel array. In some embodiments, each side of the square pixel array may be between 275 pixels and 325 pixels. In some embodiments, the lock-in camera 150 may include an analog-to-digital converter configured to output a digital signal based on the detected spectrally dispersed measurement signal 172.

### III. EXAMPLE RESULTS

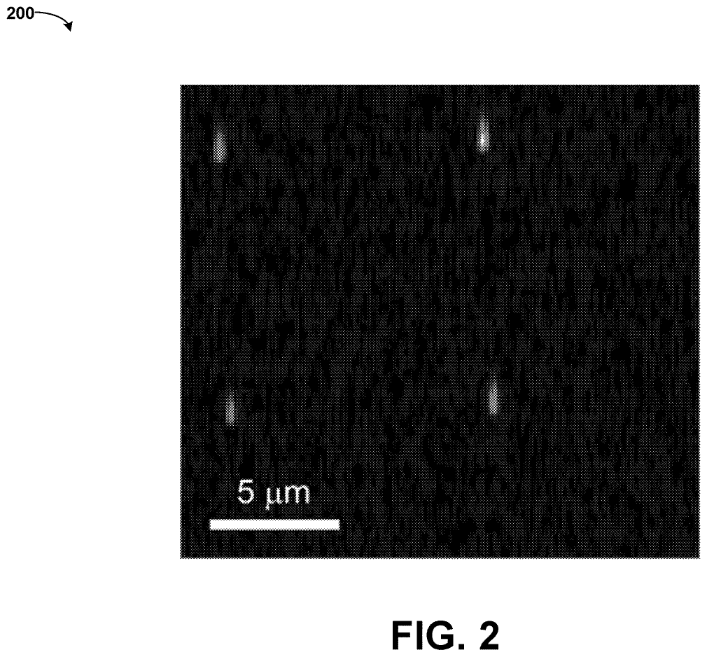

FIG. 2 is a transient transmission image 200, according to example embodiments. The transient transmission image 200 may be a 20 μm×20 μm transient transmission image of a 2×2 array containing 120 (left) and 140 (right) nm AuNDs using 400 nm pump and 800 nm probe. In FIG. 2, the elongated shape of the point spread function may be an artifact due to fast scanning along the vertical direction. FIG. 2 may demonstrate achievement of diffraction-limited imaging of individual AuNDs.

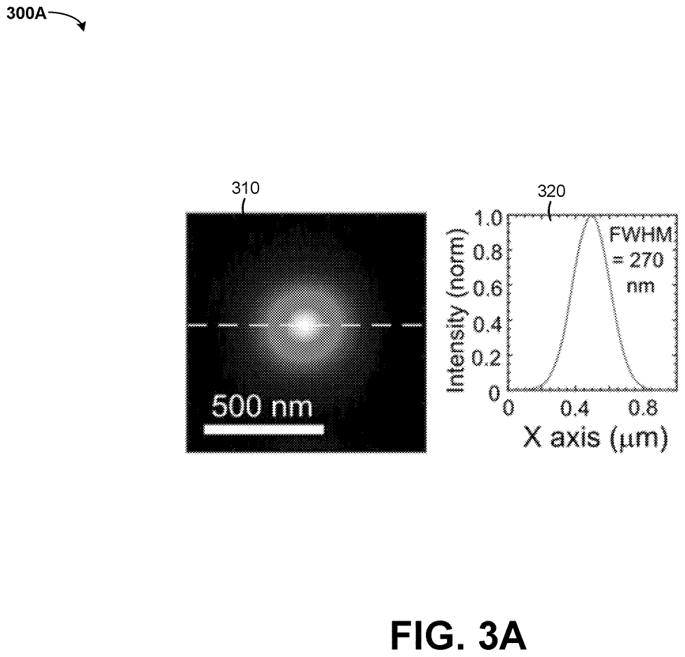

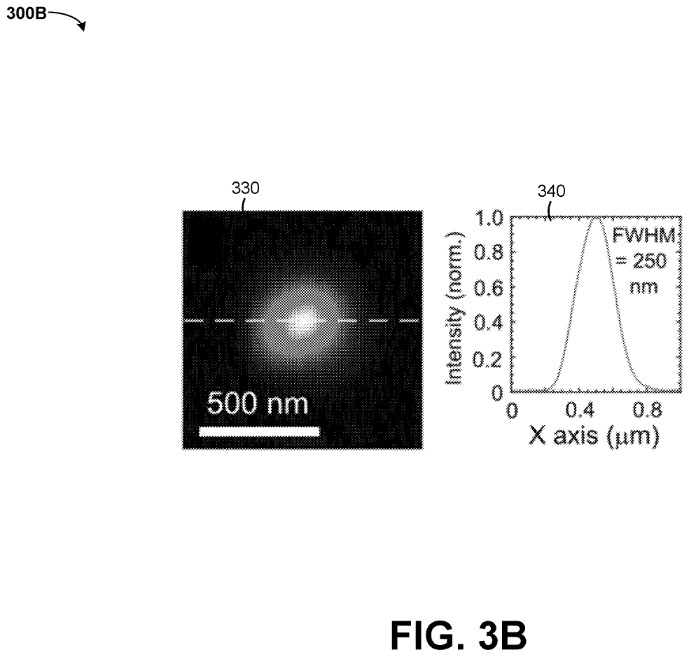

FIG. 3A is an illustration 300A of a magnified image 310 of a single 120 nm AuND and corresponding line profile 320, according to example embodiments. In FIG. 3A, the magnified image 310 may be a 1 μm×1 μm image. In FIG. 3A, the corresponding line profile 320 may yield a full width at half maximum (FWHM) value of approximately 270 nm, which may be consistent with diffraction-limited resolution. FIG. 3A may have improved characterization of a point spread function shown in FIG. 2. The magnified image 310 may be a raster-scanned image of only a single 120 nm disk using a 400 nm pump beam (e.g., pump signal 164) and an 800 nm probe beam (e.g., probe signal 166).

FIG. 3B is an illustration 300B of an image 330 of a 120 nm AuND and corresponding line profile 340, according to example embodiments. In FIG. 3B, the image 310 may be a 1 μm×1 μm image and may be generated using the entire white light continuum as a probe (e.g., probe signal 166). In FIG. 3B, the corresponding line profile 340 may yield a FWHM of about 250 nm, which, where a peak probe wavelength is near 650 nm (e.g., where probe signal 166 has a peak wavelength near 650 nm), may agree with diffraction-limited imaging. In some embodiments, intensities may be normalized.

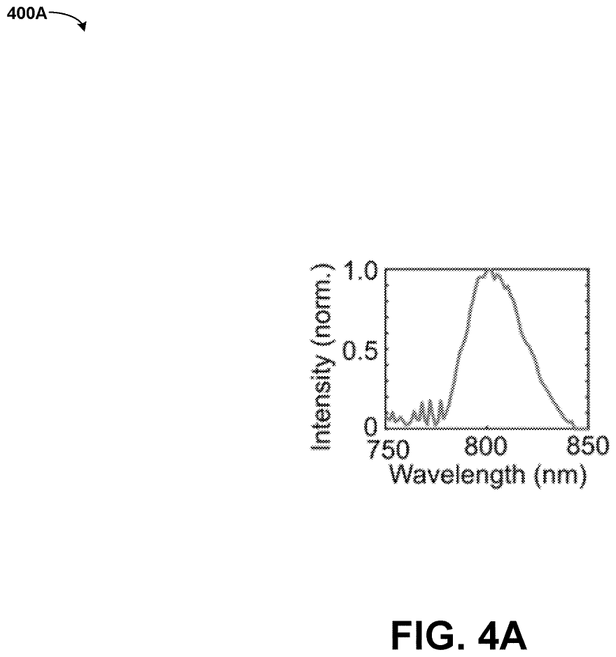

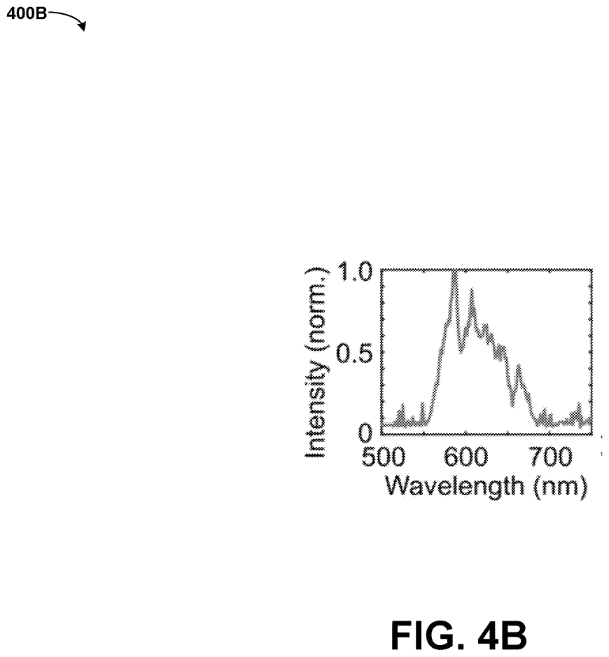

FIG. 4A is a graph 400A of a spectrum of an 800 nm probe (e.g., probe signal 166), according to example embodiments.

FIG. 4B is a graph 400B of a spectrum of a white light continuum probe (e.g., probe signal 166), according to example embodiments. In some embodiments, the spectral width can be increased by boosting the laser power sent into the pump source 122. In some embodiments, a narrower spectral width may reduce intensity fluctuations.

In some embodiments, for transient transmission imaging, a photodiode (e.g., a FEMTO® DHPCA-100-F) may be connected to a lock-in amplifier (e.g., a ZURICH INSTRUMENTS® UHFLI). In some embodiments, the lock-in amplifier may demodulate a signal using the frequency of the pump beam (e.g., pump signal 164) modulation as a reference input, yielding as output the pump-induced transmitted signal ΔT, which may be digitized with a data acquisition board (e.g., a NATIONAL INSTRUMENTS® USB-6229), collected with a custom LABVIEW® program, and processed using MATLAB®. To determine the reference transmission signal with the pump off, the signal from the photodiode may be referenced simultaneously to a laser repetition rate, allowing for real-time normalization and thus recording of the normalized differential transient transmission ΔT/T.

For transient transmission spectroscopy of nanoparticles (e.g., the at least one nanoparticle 134), a spectrometer may be used that is based on a transmission grating with a groove density of 300/mm and a blaze angle of 17.5° (e.g., an EDMUND OPTICS® Article #49579) to spectrally disperse the probe beam onto a pixel-array lock-in camera (e.g. a Heliotis heliCam™ C3). A lens with a focal length of 100 mm may be placed between the transmission grating and the lock-in camera. The camera may include an array of 300×300 pixels that each offer lock-in capabilities and analog-to-digital conversion. By spreading the spectrum across the pixel array, it may facilitate acquisition of ΔT over multiple wavelengths simultaneously using a high repetition rate femtosecond oscillator. To extract the transient transmission signal, the pump modulation frequency e.g., of 8 kHz) may be synchronized with the lock-in camera. The transient transmission spectra may be processed using the same LABVIEW® program and analyzed in MATLAB®. Wavelength calibration and correction for temporal chirp of the probe beam may be performed. Each acquired frame may be collected by integrating over 160 cycles. The final output signal may be averaged over 80 frames to achieve a high signal-to-noise ratio (SNR). While further increasing the number of collected cycles or frames may be limited by camera memory, additional post-acquisition averaging may offer a pathway to higher SNRs. Such post-acquisition averaging may not be performed. The lock-in camera may be operated in an intensity mode to obtain transmission spectra without the pump. These spectra may be used to correct for the intensity profile of the probe beam. Example spectral profiles of the fundamental 800 nm and white light continuum probe pulses are shown and described with respect to FIG. 4A and FIG. 4B.

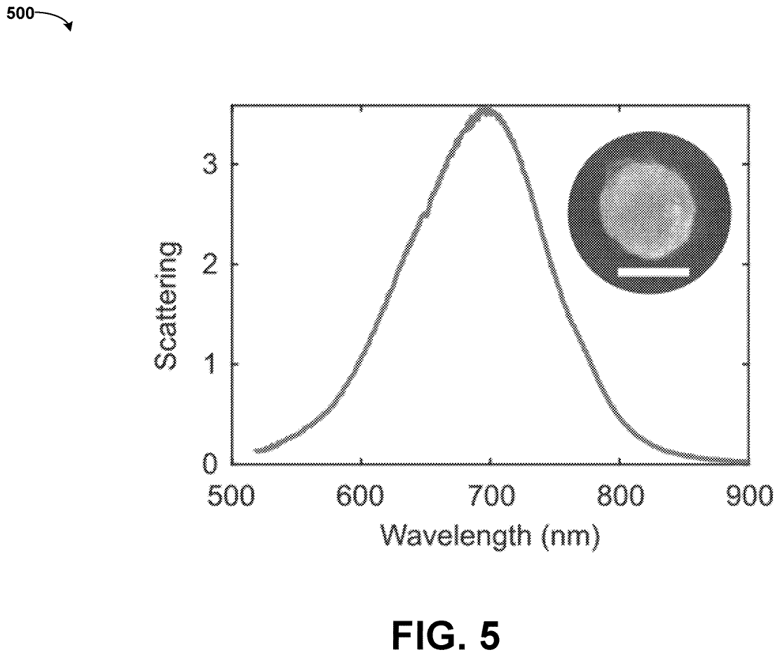

FIG. 5 is a graph 500 of a dark-field scattering (DFS) spectrum of a 140 nm AuND with its corresponding scanning electron microscope (SEM) image, according to example embodiments. In FIG. 5, the scale bar may represent 100 nm.

To compare the performance of the lock-in camera with the single-element photodiode, transient transmission measurements of a 140 nm AuND may be performed using 800 nm as a probe.

In FIG. 5, SEM analysis may confirm a diameter of 137 nm, which may be close to the size expected based on the sample design. As the DFS spectrum may peak at 700 nm, the 800 nm probe beam may report dynamics at the lower energy wing of the plasmon resonance.

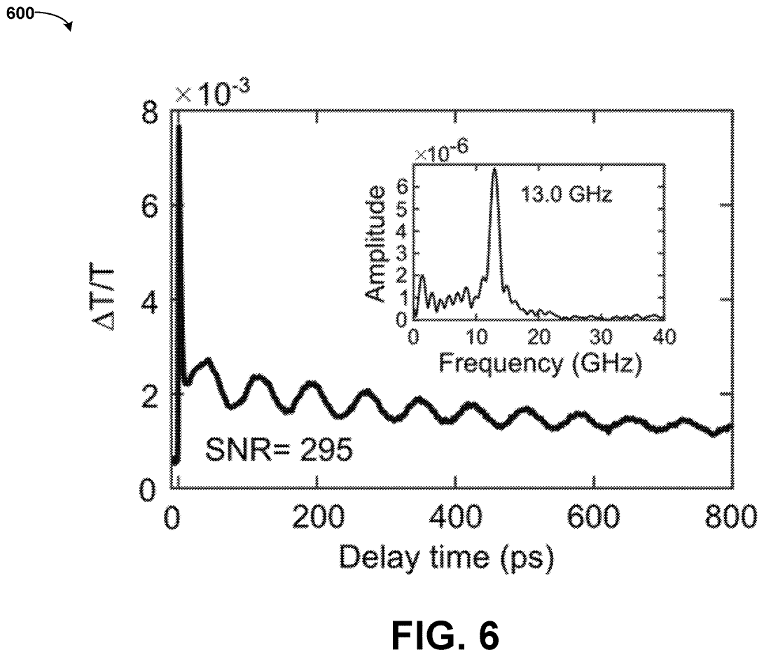

FIG. 6 is a graph 600 of time-dependent transient transmission traces, according to example embodiments. FIG. 6 may be a time-dependent transient transmission of the same AuND as depicted in FIG. 5, measured with an integration time per delay step of 600 ms. The SNR may be calculated as the maximum signal subtracted by the offset signal before zero delay time and normalized by the standard deviation of the offset signal. The inset to graph 600 may depict the power spectrum obtained by Fourier transform of the oscillatory part of the transient transmission, which may yield an acoustic mode frequency of 13.0 gigahertz (GHz).

FIG. 6 may include the ΔT/T time transient recorded with the photodiode by positioning a single AuND at the focus of the overlapped pump and probe beams and scanning the time delay separating them. In some embodiments, such data may show an instrument-limited fast rise in induced transmission caused by plasmon bleaching in response to creation of a hot electron distribution followed by a picosecond decay of this signal due to electron-phonon coupling and subsequent slower thermal equilibration with the supporting substrate. Such results may be consistent with other transient transmission measurements of single AuNDs.

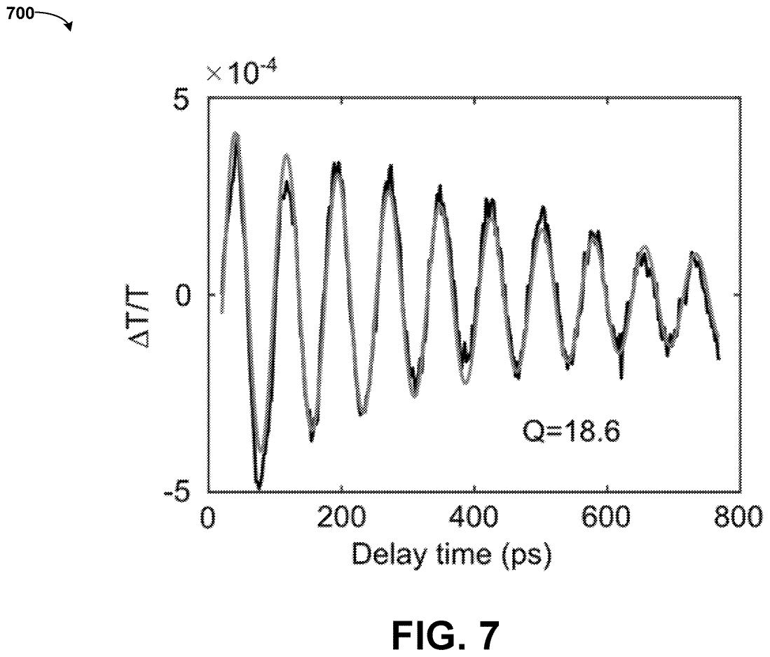

FIG. 7 is a graph 700 of an acoustic oscillation signal, according to example embodiments. FIG. 7 may depict an acoustic oscillation signal (e.g., the acoustic mode of a single 140 nm AuND) isolated from the data in FIG. 6 by subtraction of an exponential fit (black). This acoustic oscillation signal may be fit to a damped exponential decay (gray).

In some embodiments, transient signals may be compared with signals recorded using a lock-in camera. This may be facilitated by exploring the latter decay component, which may be modulated due to the excitation of acoustic modes by impulsive heating when the electrons couple to the metal's phonon bath. These acoustic oscillations may be isolated as the residuals of the time transient after subtraction of an exponential decay that may be fit to the data considering only delay times longer than 20 picoseconds (ps). These oscillations may be described by a quality factor Q, which may be defined as Q=πτν, where ν is the oscillation frequency and τ is the damping time.

The damped exponential decay fit may be expressed as using a damped cosine function according to:

$$\frac{Δ T}{T} ( t ) ∼ {e}^{- \frac{t}{τ}} \times cos ( 2 πτ t + φ ) , \qquad ( Eq . 1 )$$

where, t is the delay time between the pump and probe and p represents the oscillation phase. The oscillation frequency (e.g., 13.0 GHz) may be extracted from the Fourier transform of the acoustic oscillations. Such a cosine function fit may result in a damping time of 456 ps, which may mean that the quality factor was 18.6. Such a quality factor may be consistent with other data.

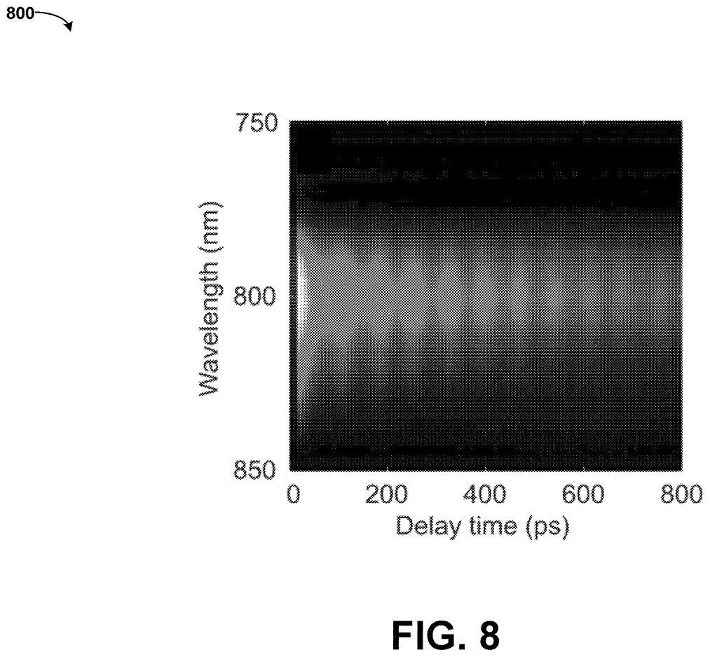

FIG. 8 is an image 800 of transient transmission spectra, according to example embodiments. The transient transmission spectra shown in FIG. 8 may be of the same AuND as shown in FIG. 5, FIG. 6, and FIG. 7. In FIG. 8, the spectra may be measured using a lock-in camera, a 400 nm pump beam and 800 nm probe beam.

In some embodiments, the lock-in camera detection for the same single 140 nm AuND under identical excitation conditions while spectrally dispersing the 800 nm probe may result in similar quality factors and performance.

As seen in FIG. 8, wavelength-resolved transient transmission dynamics of the AuND may be collected following a 400 nm pump excitation. In FIG. 8, the acoustic mode may be seen in the time-dependent transient spectra. In some embodiments, the lock-in camera may provide the benefit of improved spectral information compared with the use of a photodiode.

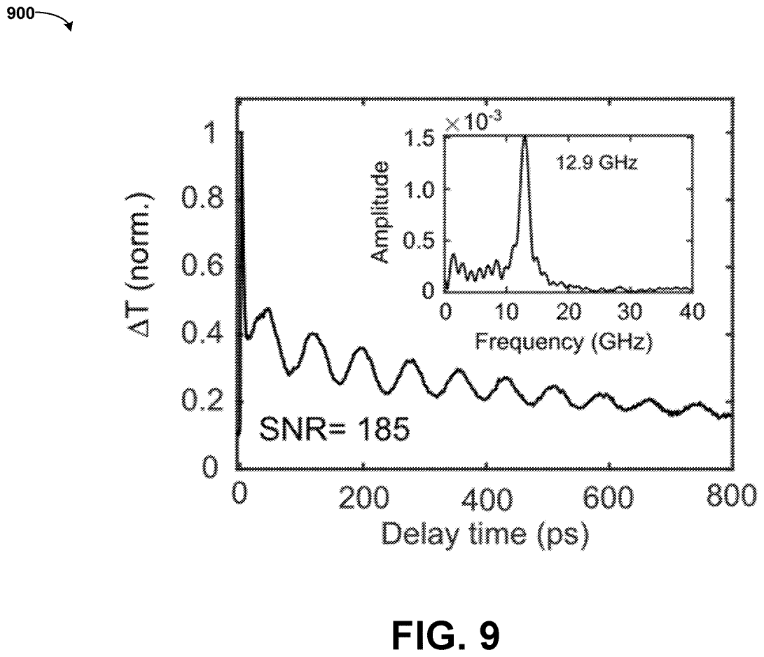

FIG. 9 is a graph 900 of a transient transmission and corresponding power spectrum, according to example embodiments. The transient transmission depicted in FIG. 9 may be generated from spectra depicted in FIG. 8, such as by integrating over the whole spectral width of the 800 nm probe at each pump-probe delay time. The integration time per delay step may be 3.2 s.

The inset in FIG. 9 depicts the power spectrum obtained by Fourier transform of the oscillatory part of the transient transmission. Doing so may yield an acoustic mode frequency of 12.9 GHz.

The sensitivities of the two detectors may be compared at a single wavelength. For such a direct comparison, the transient transmission in FIG. 8 may be averaged over the whole spectral width of the 800 nm fundamental in FIG. 9. Doing so may facilitate isolation of the oscillatory component, as described above.

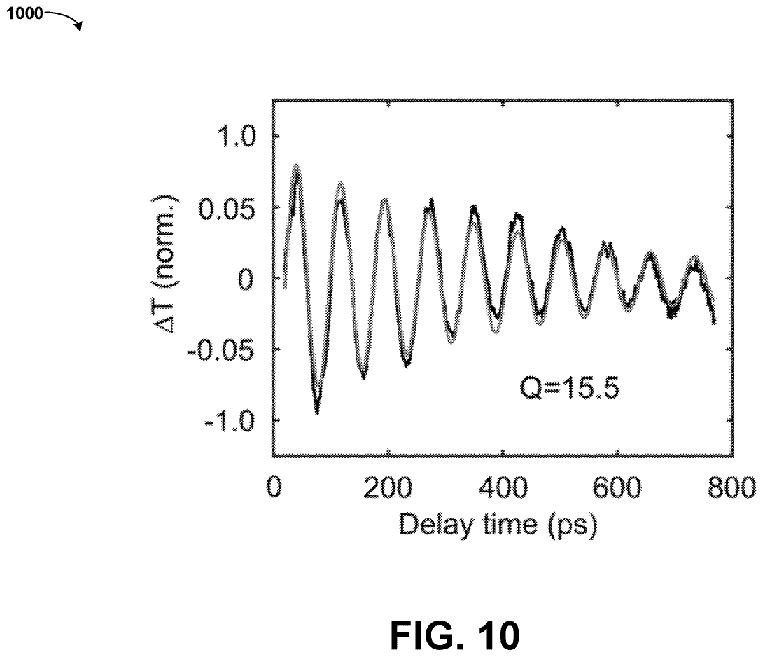

FIG. 10 is a graph 1000 of an acoustic oscillation signal, according to example embodiments.

The acoustic oscillation signal depicted in FIG. 10 may be isolated from the data in FIG. 9 by subtraction of an exponential fit. This signal may be fitted to a damped exponential decay (e.g., Eq. 1 described above). For example, fitting to Eq. 1 and Fourier transforming the data may give a frequency of 12.9 GHz and a damping time of 381 ps. This may yield a Q-factor of 15.5, which may be consistent with the results obtained for the single-element photodiode.

The SNR for the trace in FIG. 6 may be compared with the SNR for the trace in FIG. 9. The value of the SNR for the trace in FIG. 6 may be 295, while the value of the trace in FIG. 9 may be 185. These SNR values may be calculated as the maximum transient signal normalized by the standard deviation of the background noise. The background may be determined as the signal in the trace before zero delay time. In some embodiments, the integration times may differ. For example, the integration time may be 0.6 seconds per delay step for the photodiode, while the integration time may be 3.2 seconds per delay step for the lock-in camera. Considering SNR and integration time, the sensitivity (e.g., SNR/\sqrt{integration time}) for lock-in camera detection may be a factor of 3.7 smaller than that of the photodiode. In some embodiments, integrating over a 20 nm spectral slice of the probe pulses centered at 800 nm, may decrease this factor to 4.5. In some embodiments, the lock-in camera may have a sensitivity that is lower than that of the photodiode. In some embodiments, the sensitivity of the lock-in camera may facilitate recording high-quality, spectrally resolved pump-probe measurements, such as single-particle transient absorption and photothermal spectroscopy and microscopy.

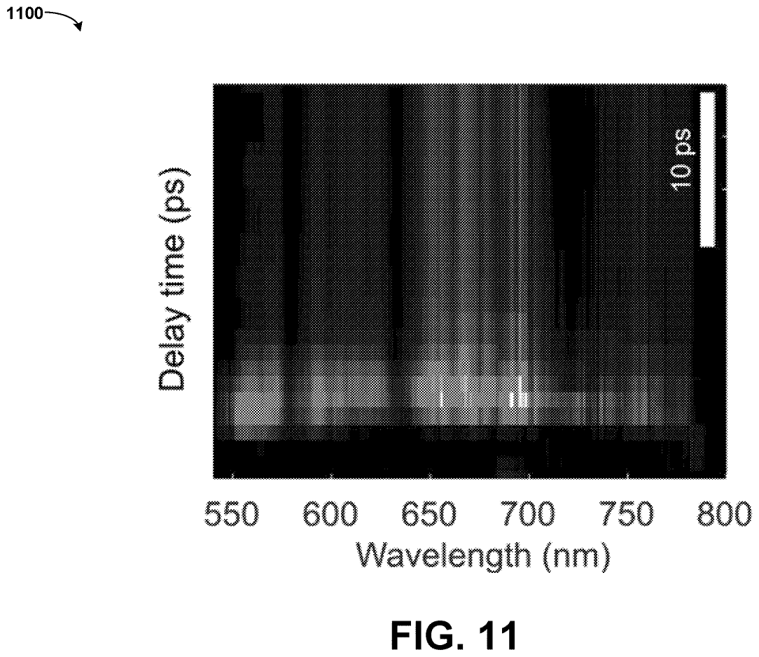

FIG. 11 is an image 1100 of time-resolved transient transmission traces, according to example embodiments. The time-resolved transient transmission may be of a single 120 nm AuND and may be based on the use of a white light continuum as the probe and the lock-in camera as the detector. The collected signal may be corrected for pulse chirp and a background, pre-time zero offset.

In some embodiments, use of a white light continuum probe may facilitate measurement of an entire transient transmission spectrum of one or more nanoparticles using the combination of the lock-in camera and a high repetition rate femtosecond oscillator. This may facilitate resolving both the initial electron relaxation dynamics and acoustic vibrations of a single 120 nm AuND (FIG. 4).

As shown in FIG. 11, transient transmission spectra of a single AuND may be plotted as a function of pump-probe delay time. These spectra may be corrected for one or more of wavelength-dependent variations in the probe intensity and camera quantum efficiency, probe pulse chirp, and a static background signal that was removed by subtracting the signal measured at negative pump-probe time delays from each wavelength channel. The maximum transient transmission may be between 650 nm and 700 nm, which may occur near the peak of the plasmon resonance of the 120 nm AuND. This result may be confirmed by a corresponding DFS spectrum. In some embodiments, a second camera may be used to obtain a background signal that may be removed rather than or in addition to the removal of the static background signal.

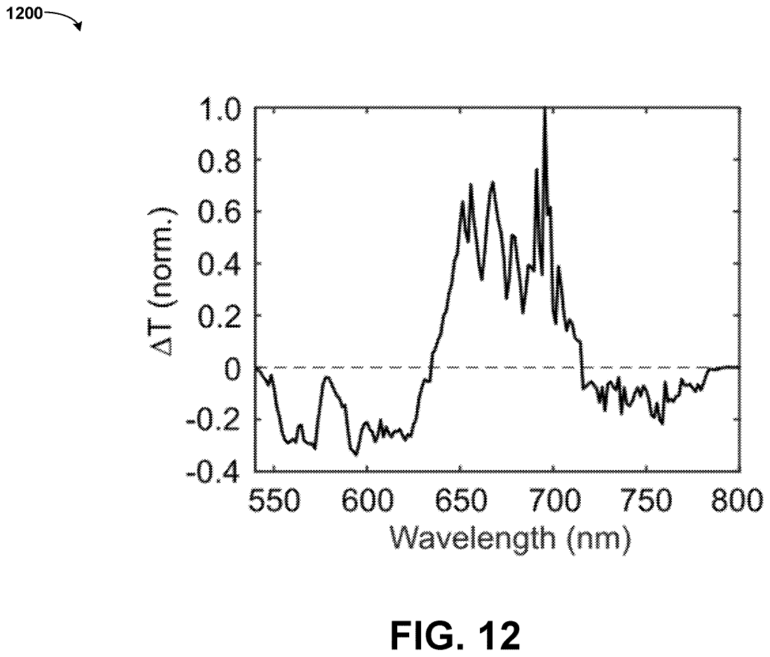

FIG. 12 is a graph 1200 of a transient transmission spectrum, according to example embodiments. The transient transmission spectrum may be averaged over pump-probe delay times of between 1 ps and 5 ps, which may be extracted from the data in FIG. 11. Further, the transient transmission spectrum may also account for the signal phase.

In some embodiments, a transient transmission spectrum may be averaged over initial electron-phonon relaxation dynamics from 1 ps to 5 ps. Further, the phase (e.g., as obtained for different probe wavelengths using the lock-in amplifier) may be accounted for. A photoinduced bleach may occur near the peak of the localized surface plasmon resonance and induced absorption at the wings, giving a spectral shape, which may be consistent with ensemble transient extinction measurements. This shape may result from spectral broadening of the plasmon due to an elevation of the nanoparticle's electronic temperature following light absorption. The sharp features of the single-particle transient transmission spectrum may arise from fluctuations of the white light continuum. Future improvements in stability together with an enhanced algorithm for probe intensity correction may reduce such sharp features.

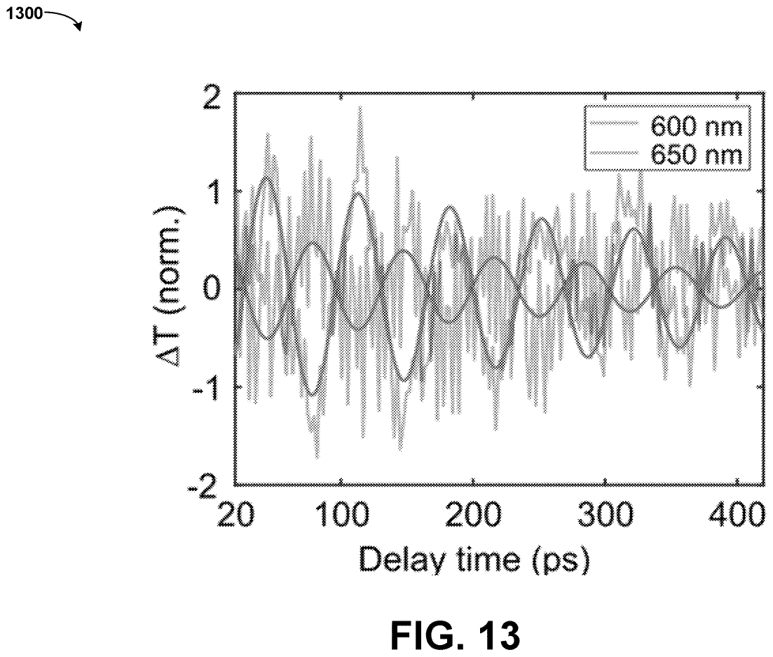

FIG. 13 is a graph 1300 of acoustic oscillations and best fit lines, according to example embodiments. The best fit lines for the acoustic oscillations may be based on Equation 1 (above), may be for two probe wavelengths (e.g., with centers at 600 nm and 650 nm), and/or may be averaged over spectral windows of 20 nm. The oscillations may be out of phase, which may be consistent with the change in the sign of the transient transmission that may be observed in FIG. 12.

In addition to improved spectral information, an advantage of the lock-in camera setup may be that the dynamics at different wavelengths may be incorporated quickly, as described in greater detail for acoustic vibrations and electron-phonon relaxation of the 120 nm AuND (below). The acoustic oscillations at 600 nm and 650 nm, described above, may be found to be out of phase (e.g., with similar oscillation frequencies of 14.5 GHz and 14.4 GHz, respectively). This may be consistent with the phase change that may be observed in the transient transmission spectrum and may be caused by a periodic plasmon resonance shift due to the changes in particle volume induced by the acoustic breathing mode. The 800 nm fundamental may be used as the probe and may have higher stability and hence increased SNR. The use of the 800 nm fundamental in this way may confirm an oscillation frequency of 14.2 GHz for another 120 nm AuND.

To compare SNRs between measurements of acoustic oscillations using 800 nm fundamental and white light continuum as probe, SNRs may be calculated as the transient signal averaged over 400 ps normalized by the standard deviation of the residuals from the cosine fit described above in reference to Equation 1. The SNR using the 800 nm fundamental may be 6.7 and the SNR using the white light continuum may be 3.2. This may indicate that instabilities of white light continuum lower the SNR by about a factor of 2 near the plasmon resonance.

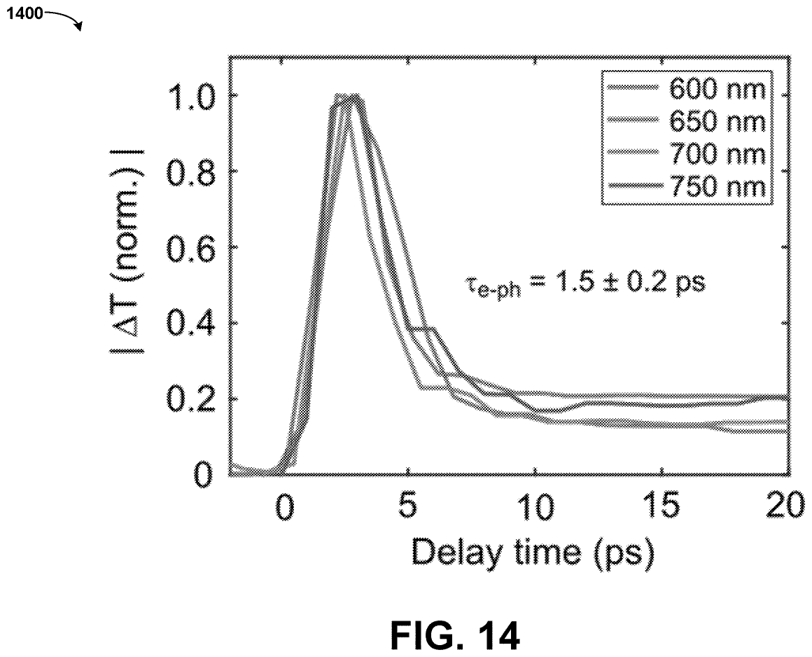

FIG. 14 is a graph 1400 of short-time ultrafast transient dynamics, according to example embodiments. These short-time ultrafast transient dynamics may probe electron-phonon relaxation and may be simultaneously measured at four different probe wavelengths. These dynamics may be plotted as data traces, with each data trace being constructed by averaging the transient transmission displayed in FIG. 11 over a spectral window of 20 nm centered at each listed probe wavelength. An exponential fit may yield an electron-phonon relaxation time of τₑ₋ₚₕ=1.5 ps±0.2 ps. The integration time per delay step may be 3.2 seconds.

In addition to spectral information, an advantage of the lock-in camera setup is that the dynamics at different wavelengths may be available instantly as illustrated for the electron-phonon relaxation shown in FIG. 14.

FIG. 14 may highlight that both the plasmon bleach and induced absorptions at shorter and longer probe wavelengths may have the same decay times. This observation that the electron-phonon relaxation is independent of probe wavelength may reflect the cooling of the hot electron distribution that may give rise to transient plasmon damping. These results may be consistent with ensemble transient absorption spectroscopy of gold nanospheres because measured electron-phonon relaxation time may depend only on the rise in electron temperature.

The use of a lock-in camera as described herein may provide one or more benefits because the use of such a camera may facilitate the simultaneous recording of time-resolved dynamics over a broad wavelength range of several hundred nanometers. Instead of imaging at a fixed wavelength, results described herein may suggest that spectroscopy of one or more nanoparticles may be conducted with MHz repetition rate ultrafast lasers.

In some embodiments, a lock-in camera may have a two-dimensional pixel array and one line of pixels from that array may be used. A full-chip lock-in imaging may facilitate spectroscopy of multiple nanoparticles simultaneously, like hyperspectral imaging.

Improving the stability of the white light continuum and its real-time correction may improve performance. Direct measurement of phase information may also improve performance. Real-time corrections may be performed by using the pixel-array (e.g., using one line of pixels to measure the continuum for reference and another line of pixels for the transient transmission measurements). Further, the use of a lock-in camera, as described herein may be used for single-particle transient extinction spectroscopy, single-particle pump-probe modulation spectroscopy, and wide-field imaging.

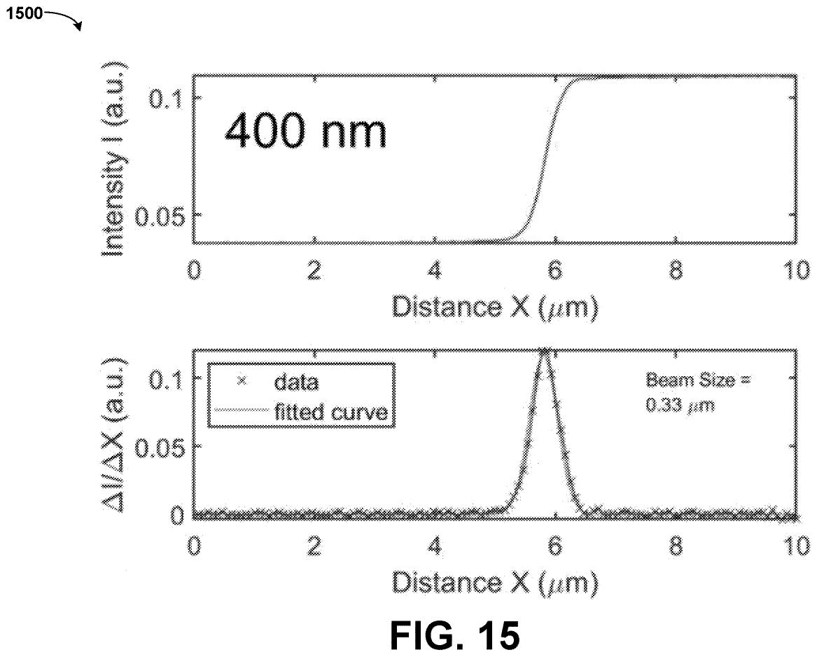

FIG. 15 illustrates graphs 1500 of measurements of the beam size for a 400 nm beam, according to example embodiments. Measurements of the beam size using the knife-edge method may yield beam sizes down to approximately 250 nm, which may suggest that an optical diffraction limit was achieved. Beam sizes may be calculated as the FWHM by fitting the measurements to a Gaussian function.

In some embodiments, the beam size for the pump beam may be 400 nm and may be measured using the knife-edge method. As depicted in FIG. 15, line profiles along the x-axis for the corresponding beam profiles of the pump beam may be shown.

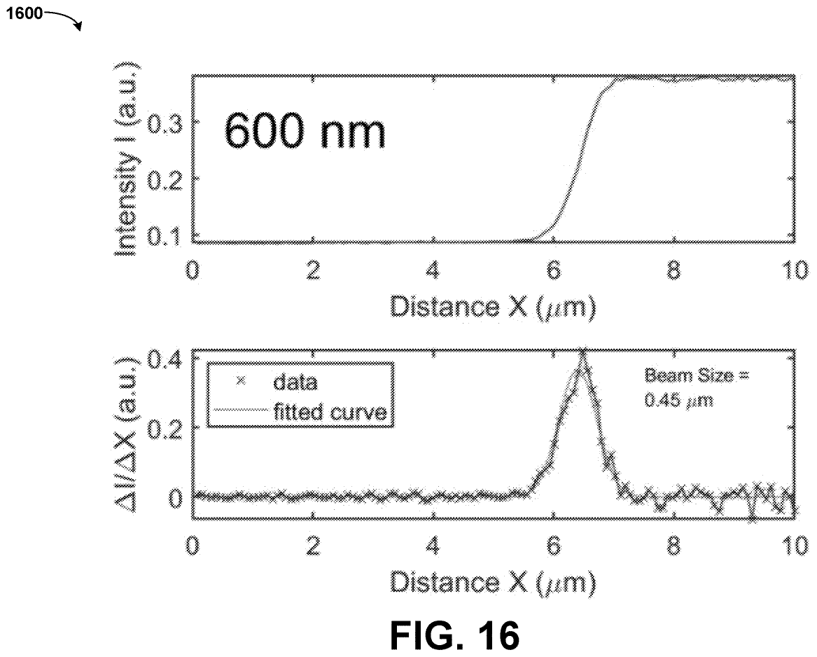

FIG. 16 illustrates graphs 1600 of measurements of the beam size for a 600 nm beam, according to example embodiments. The beam size for the 600 nm probe beam may be measured using the knife-edge method. For the probe beam, a spectral slice of 25 nm may be used for the beam size determination. As depicted in FIG. 16, line profiles along the x-axis for the corresponding beam profiles of the probe beam may be shown.

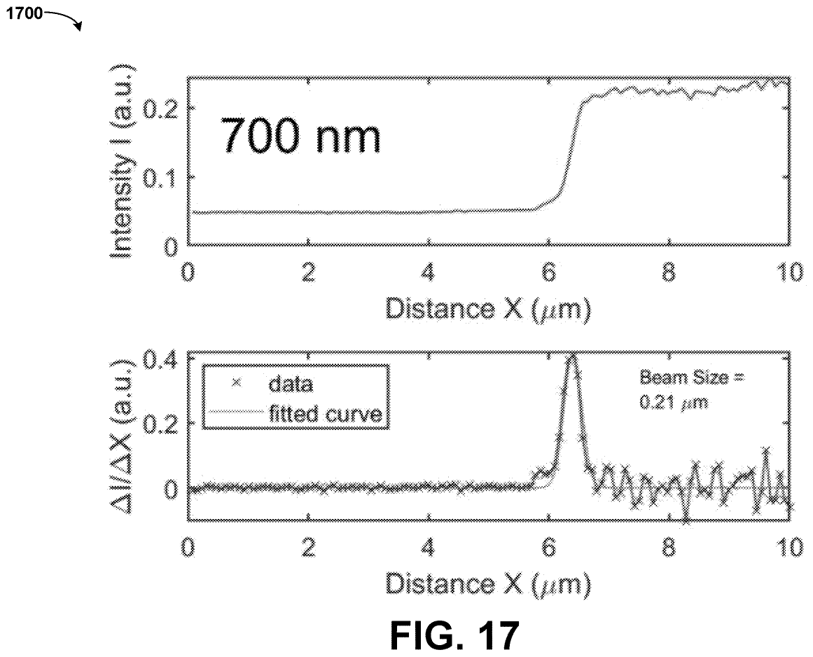

FIG. 17 illustrates graphs 1700 of measurements of the beam size for a 700 nm beam, according to example embodiments. The beam size for the 700 nm probe beam may be measured using the knife-edge method. For the probe beam, a spectral slice of 25 nm may be used for the beam size determination. As depicted in FIG. 17, line profiles along the x-axis for the corresponding beam profiles of the probe beam may be shown.

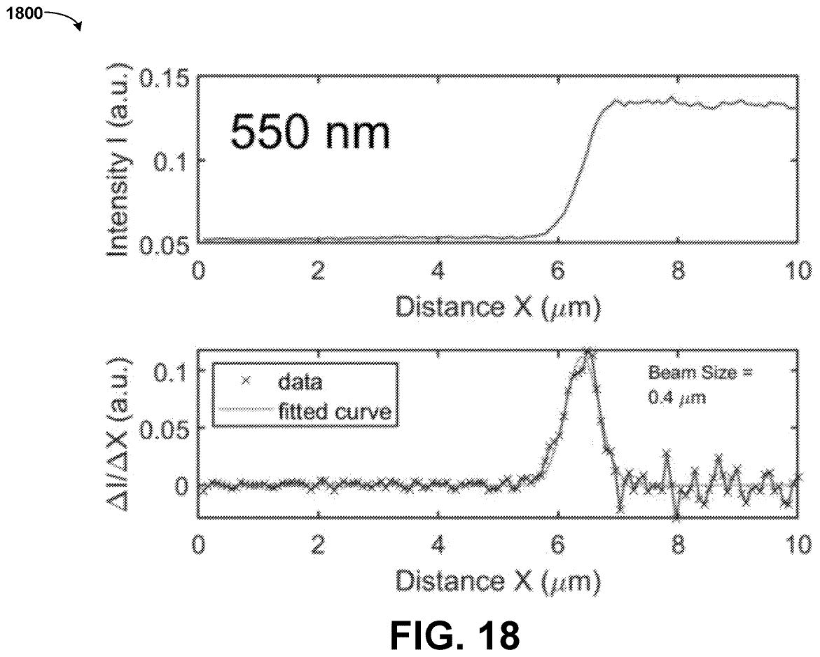

FIG. 18 illustrates graphs 1800 of measurements of the beam size for a 550 nm beam, according to example embodiments. The beam size for the 550 nm probe beam may be measured using the knife-edge method. For the probe beam, a spectral slice of 25 nm may be used for the beam size determination. As depicted in FIG. 18, line profiles along the x-axis for the corresponding beam profiles of the probe beam may be shown.

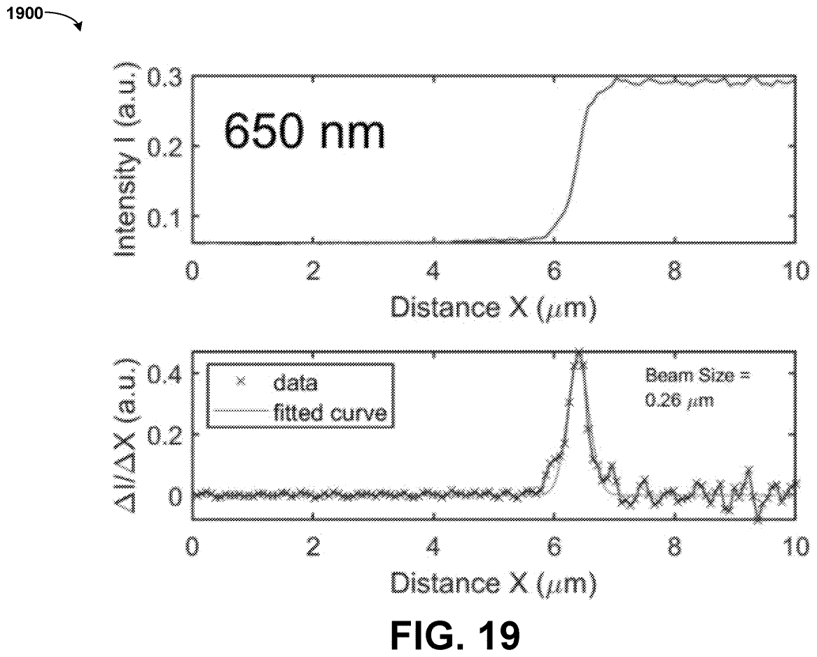

FIG. 19 illustrates graphs 1900 of measurements of the beam size for a 650 nm beam, according to example embodiments. The beam size for the 650 nm probe beam may be measured using the knife-edge method. For the probe beam, a spectral slice of 25 nm may be used for the beam size determination. As depicted in FIG. 19, line profiles along the x-axis for the corresponding beam profiles of the probe beam may be shown.

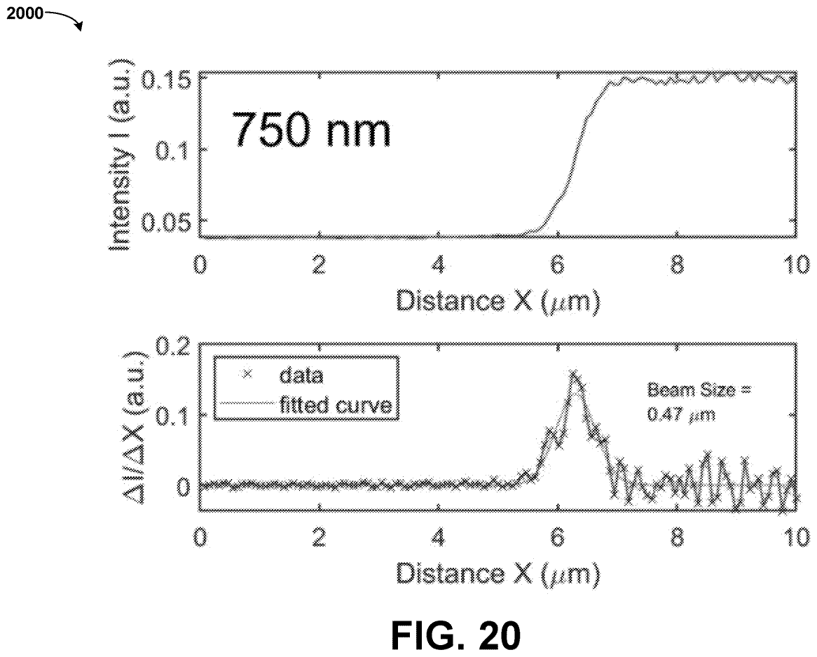

FIG. 20 illustrates graphs 2000 of measurements of the beam size for a 750 nm beam, according to example embodiments. The beam size for the 750 nm probe beam may be measured using the knife-edge method. For the probe beam, a spectral slice of 25 nm may be used for the beam size determination. As depicted in FIG. 20, line profiles along the x-axis for the corresponding beam profiles of the probe beam may be shown.

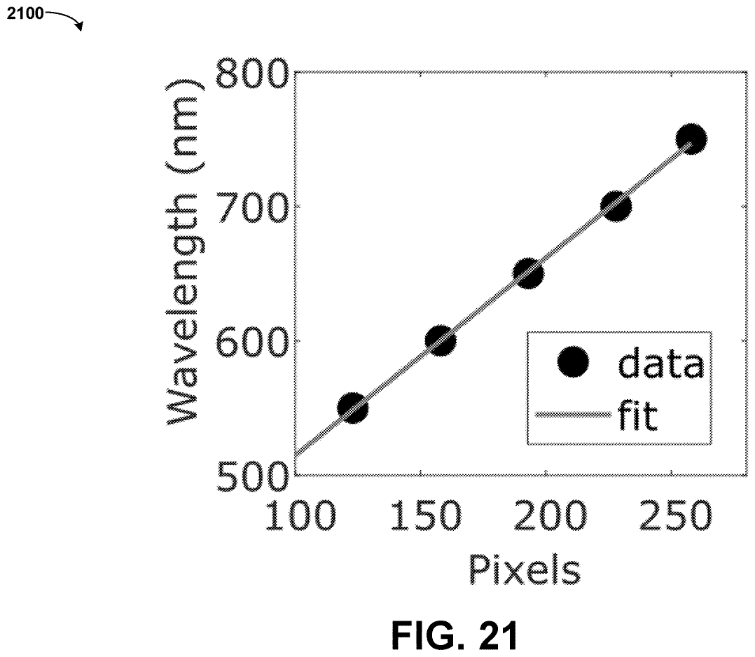

FIG. 21 illustrates a graph 2100 of wavelength calibration measurements, according to example embodiments. The wavelength calibration measurements may be for the lock-in camera. In some embodiments, five different probe wavelengths from the white light continuum may be used to calibrate the pixels of the lock-in camera via a linear fit.

In some embodiments, camera calibration and data processing procedures may be developed to convert the measured signal of the lock-in camera into transient transmission spectra. This procedure may include, as a first step, determining the wavelength-pixel relationship by observing the pixel columns at which known slices of the white light continuum or a white light lamp (e.g., an argon lamp) were detected. Bandpass filters may be selected to choose a specific wavelength from the white light continuum for the pixel calibration. For example, known 550 nm, 600 nm, 650 nm, 700 nm, and 750 nm wavelengths may be used for the pixel-wavelength relationship. By employing a linear fit to the measured data points, each pixel may be ascribed to a specific wavelength.

The procedure may include as a second step correcting for both the power distribution of the white light continuum and the wavelength-dependent quantum efficiency of the lock-in camera by measuring a white light correction spectrum by running the camera in a regular intensity mode without lock-in amplification. Dividing measured transient transmission signals, ΔT, by the correction spectrum may facilitate the determination of wavelength-dependent power and quantum efficiency corrections.

The procedure may include, as a third step, determining and accounting for pulse chirping. In some embodiments, the measured transient transmission spectrum may indicate the existence of pulse chirping (e.g., the delay time at which the signal for each wavelength was first observed, time zero, shifted with increasing wavelength towards longer delay times). Such chirping may reflect temporal broadening of the white light continuum probe pulses and may be induced, at least in part, by the wavelength dependence of the refractive index when passing through any optical element, such as filters, dichroic mirrors, and objectives.

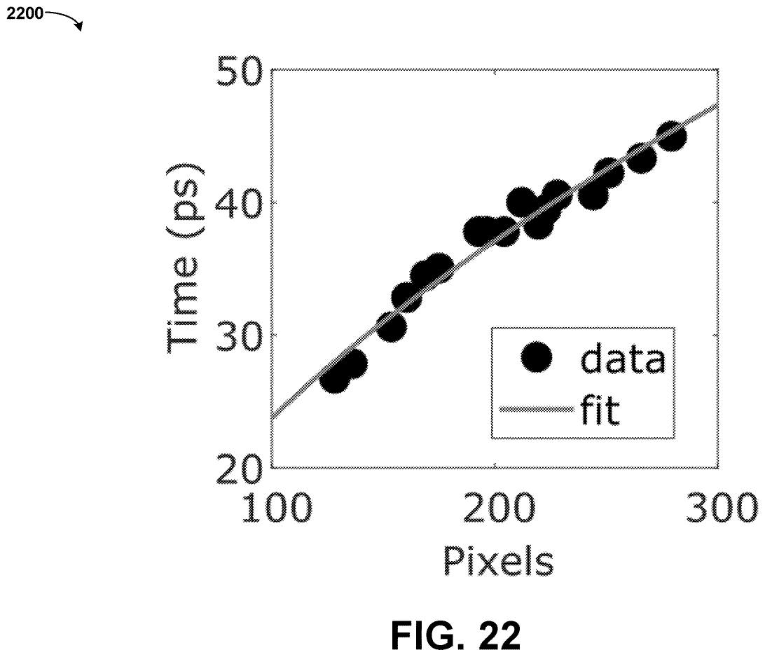

FIG. 22 illustrates a graph 2200 of probe beam chirp correction measurements, according to example embodiments. In some embodiments, probe beam chirp correction may be facilitated by manually selecting pixels of the lock-in camera for the zero pump-probe delay time corresponding to each wavelength and fitting a square root dependency (e.g., a\sqrt{x}+b) to the manually selected pixels.

In some embodiments, various data points may be manually selected along the wavelength axis. These datapoints may be fit to a square root function, which may identify time zero for each wavelength. Shifting the data for each wavelength to the identified time zero, may facilitate chirp-corrected transient transmission spectra as shown above.

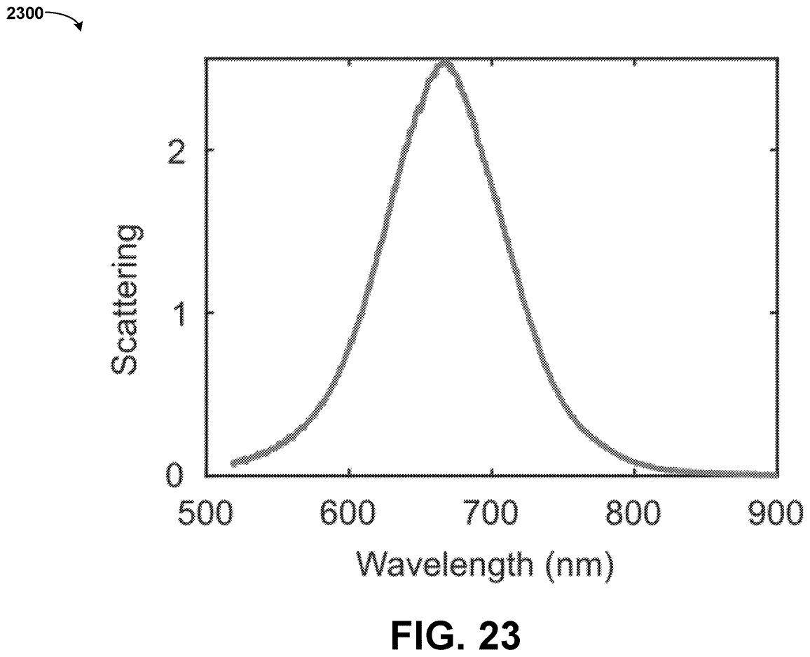

FIG. 23 is a graph 2300 of the DFS spectrum of a 120 nm AuND, according to example embodiments.

As shown inf FIG. 23, the DFS spectrum of a single 120 nm AuND may have a plasmon resonance at 665 nm. This may support the analyses described above.

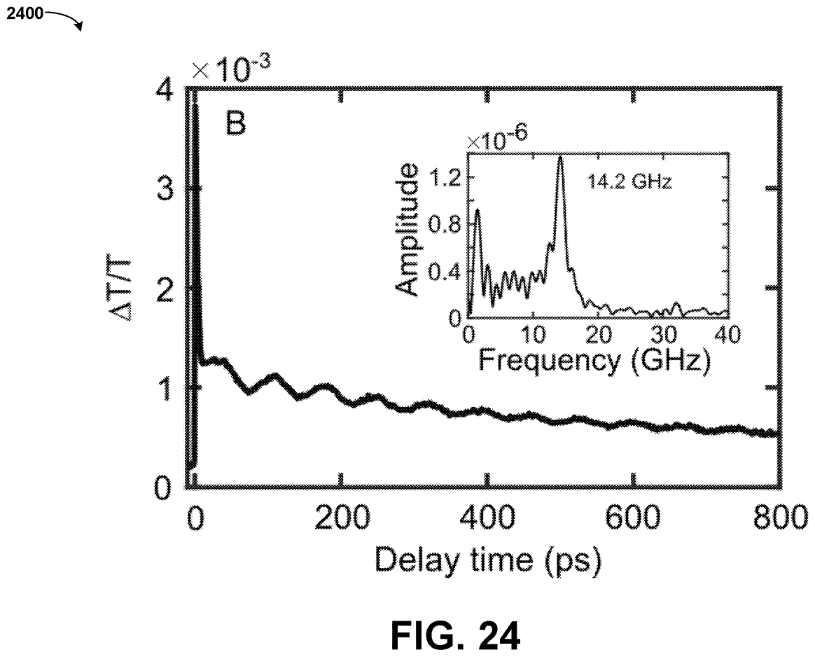

FIG. 24 illustrates a graph 2400 of a transient transmission and corresponding power spectrum, according to example embodiments. The transient transmission may be of the same AuND as in FIG. 23. The inset in FIG. 24 may include the power spectrum obtained by Fourier transform of the residuals after subtracting an exponential fit from the signal, which may yield a frequency of 14.2 GHz.

In some embodiments, time transients and extracted acoustic oscillations measured with a photodiode and lock-in detection may yield an acoustic frequency of 14.2 GHz, which may be comparable to the acoustic oscillations measured with the lock-in camera.

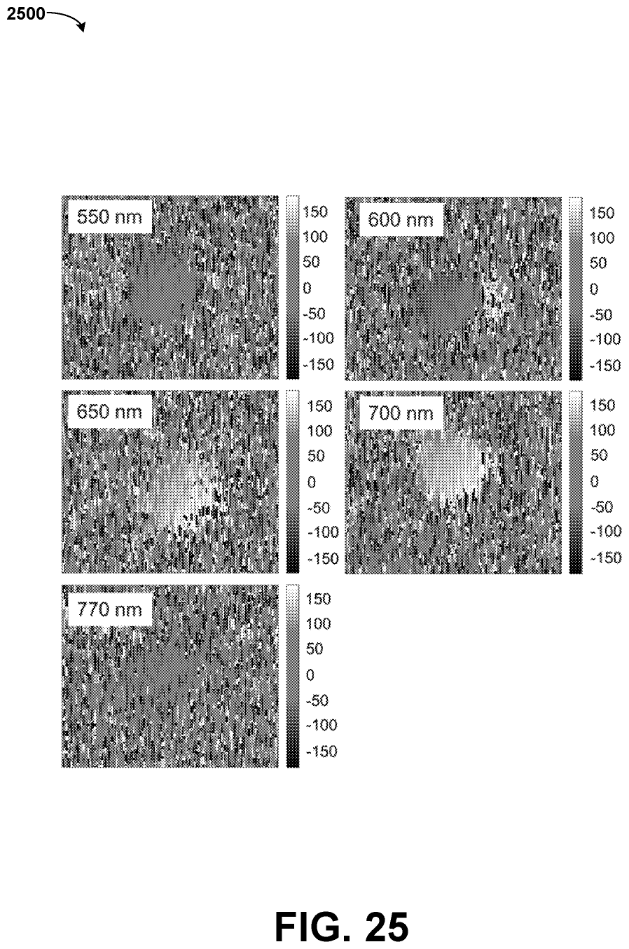

FIG. 25 illustrates phase measurements 2500 of a single 120 nm AuND at different probe wavelengths, according to example embodiments. The wavelengths for the measurements may be selected by passing the white light continuum probe through a bandpass filter with a spectral width of 25 nm. The phase measurements 2500 depicted in FIG. 25 may be collected using a 400 nm excitation beam (e.g., pump signal 164), which may excite interband transitions of the AuND. The transient transmission signals may be detected using a photodiode. The corresponding probe wavelengths may be described in the insets. The sub-portions of FIG. 25 may be created by scanning the sample stage at a fixed pump-probe delay time.

In some embodiments, to determine the sign of the transient transmission, the phase of the signal from the lock-amplifier may be recorded for measurements with 400 nm pump and different probe wavelengths between 550 nm and 770 nm. Phase measurements may be performed using a lock-in amplifier. This resulting phase information may be incorporated into the transient spectrum described above.

The methods and systems described herein include the use of a pixel-array lock-in camera and a time-resolved transient transmission microscope to measure the temporally and spectrally resolved ultrafast dynamics of single nanoparticles. Using lithographically prepared single AuNDs as a test sample, experimental instrumentation, and calibration procedures, and normalization procedures may be determined to acquire time-resolved single-particle spectra. The acquired spectra displaying broadening of the plasmon lineshape may follow ultrafast excitation and may result in bleaching near the peak of the plasmon resonance and may also result in induced absorption at its edges. The lock-in camera may be able to resolve coherent acoustic vibrations of single nanoparticles. In some embodiments, the sensitivity and SNR of the lock-in camera may be comparable to the sensitivity and SNR produced by performing lock-in detection with a single-element photodiode. The use of a lock-in camera may facilitate multiplexed spectral detection of transient transmission signals. As such, lock-in camera technology may facilitate accessibility of single-nanoparticle pump-probe spectroscopy by alleviating wavelength-by-wavelength sequential scanning to acquire transient spectra, which may be slow.

### IV. EXAMPLE METHODS

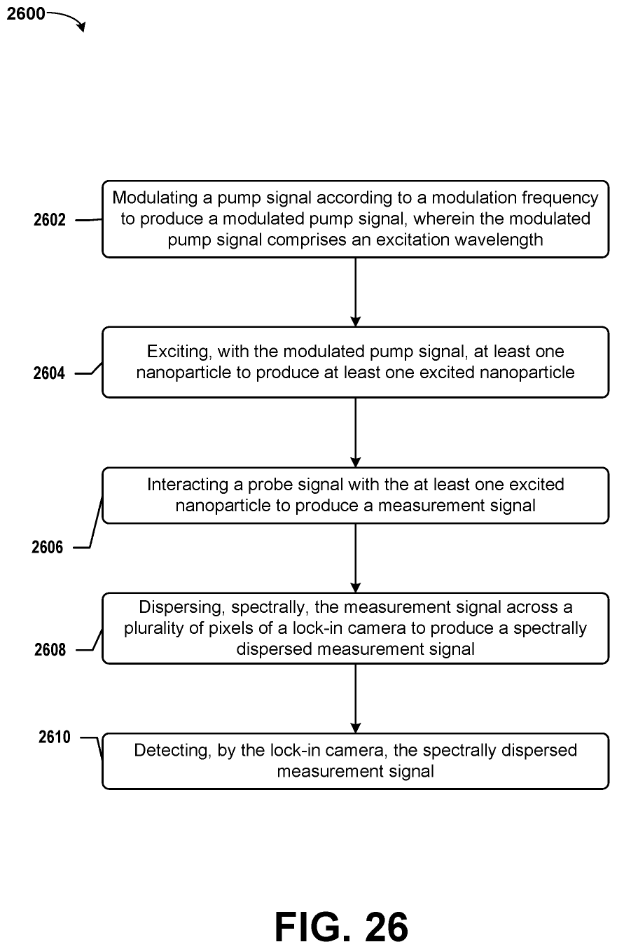

FIG. 26 is a flowchart illustration of a method 2600, according to example embodiments. Method 2600 may be performed using a system (e.g., system 100 shown and described with reference to FIG. 1).

At block 2602, method 2600 may include modulating a pump signal according to a modulation frequency to produce a modulated pump signal. In some embodiments, the modulated pump signal may include an excitation wavelength.

At block 2604, method 2600 may include exciting, with the modulated pump signal, at least one nanoparticle to produce at least one excited nanoparticle.

At block 2606, method 2600 may include interacting a probe signal with the at least one excited nanoparticle to produce a measurement signal.

At block 2608, method 2600 may include dispersing, spectrally, the measurement signal across a plurality of pixels of a lock-in camera to produce a spectrally dispersed measurement signal.

At block 2610, method 2600 may include detecting, by the lock-in camera, the spectrally dispersed measurement signal. In some embodiments, the detecting may be while moving the delay line for acquiring delay time dependent (e.g., time-resolved) transmission signal.

### V. CONCLUSION

The present disclosure is not to be limited to methods and systems for determining time-resolved transient spectra for individual nanoparticles. The methods and systems described herein may be used to determine transient spectra at the ensemble level (e.g., bulk samples of thousands of particles and/or molecules) and/or solutions that include different types of particles and/or molecules.

Further, the present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including random-access memory (RAM), a disk drive, a solid state drive, or another storage medium.

The computer-readable medium can also include non-transitory computer-readable media such as computer-readable media that store data for short periods of time like register memory and processor cache. The computer-readable media can further include non-transitory computer-readable media that store program code and/or data for longer periods of time. Thus, the computer-readable media may include secondary or persistent long term storage, like read-only memory (ROM), optical or magnetic disks, solid state drives, compact-disc read-only memory (CD-ROM), for example. The computer-readable media can also be any other volatile or non-volatile storage systems. A computer-readable medium can be considered a computer-readable storage medium, for example, or a tangible storage device.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed:

1. A system comprising:
a pump source configured to supply a pump signal having an excitation wavelength, wherein the pump signal is configured to excite at least one nanoparticle at the excitation wavelength;
a modulator configured to modulate the pump signal according to a modulation frequency;
a probe source configured to supply a probe signal to the at least one nanoparticle, wherein a measurement signal is generated when the probe signal interacts with the at least one nanoparticle when the at least one nanoparticle is excited at the excitation wavelength;
a lock-in camera comprising an image sensor having a plurality of pixels; and
a transmission grating configured to spectrally disperse the measurement signal across the plurality of pixels of the lock-in camera, wherein the lock-in camera is configured to lock-in to the modulation frequency and detect the spectrally dispersed measurement signal.

2. The system of claim 1, further comprising:
a common oscillator configured to feed both the pump source and the probe source.

3. The system of claim 2, wherein the common oscillator comprises a Ti:sapphire oscillator configured to produce pulses with a repetition rate between 10 megahertz (MHz) and 150 MHz, wherein the pulses have a pulse width between 10 femtoseconds (fs) and 10 picoseconds (ps), and wherein the pulses have a center wavelength between 700 nanometers (nm) and 1,600 nm.

4. The system of claim 3, further comprising:
a continuous-wave laser configured to pump the common oscillator, wherein the continuous-wave laser is configured to generate an oscillator-pumping signal, and wherein the oscillator-pumping signal has a power between 7 watts (W) and 10 W and a center wavelength between 528 nanometers (nm) and 536 nm.

5. The system of claim 1, wherein the at least one nanoparticle comprises a gold nanodisk, wherein the pump signal has a center wavelength between 350 nanometers (nm) and 1,600 nm, and wherein the pump source comprises a beta barium borate crystal.

6. The system of claim 1, wherein the probe source comprises a non-linear photonic crystal fiber.

7. The system of claim 1, wherein the probe signal comprises light spanning wavelengths from a first wavelength to a second wavelength, wherein the first wavelength is between 525 nanometers (nm) and 575 nm, and wherein the second wavelength is between 760 nm and 1,600 nm.

8. The system of claim 7, wherein the probe source comprises a short-pass filter configured to attenuate light having wavelengths above the second wavelength.

9. The system of claim 1, wherein the modulator comprises a mechanical optical chopper.

10. The system of claim 1, wherein the modulation frequency is between 2 kilohertz (kHz) and 250 kHz.

11. The system of claim 1, further comprising:
an upstream microscope objective configured to focus the pump signal and the probe signal on the at least one nanoparticle, wherein the focused pump signal has enhanced intensity relative to the pump signal, and wherein the focused probe signal has enhanced intensity relative to the probe signal.

12. The system of claim 11, wherein the upstream microscope objective is configured to focus the pump signal and the probe signal to a diffraction limit on the at least one nanoparticle.

13. The system of claim 11, wherein the upstream microscope objective comprises an objective, and wherein a numerical aperture of the upstream microscope objective is between 0.1 and 1.4.

14. The system of claim 1, further comprising:
a dichroic mirror configured to align the pump signal and the probe signal with one another prior to the pump signal and the probe signal arriving at the at least one nanoparticle.

15. The system of claim 14, further comprising:
a low-pass filter configured to attenuate the pump signal after the pump signal has excited the at least one nanoparticle and prior to the pump signal reaching the lock-in camera.

16. The system of claim 1, further comprising:
a lens configured to focus the measurement signal onto the plurality of pixels of the lock-in camera.

17. The system of claim 1, wherein the transmission grating comprises a groove density of between 150 groves per millimeter (grooves/mm) and 1,200 groves/mm, and wherein the transmission grating has a blaze angle of between 8.6° and 36.9°.

18. The system of claim 1, wherein the plurality of pixels is arranged in a square pixel array, wherein each side of the square pixel array is between 275 pixels and 325 pixels, and wherein the lock-in camera comprises an analog-to-digital converter configured to output a digital signal based on the detected spectrally dispersed measurement signal.

19. A method comprising:
modulating a pump signal according to a modulation frequency to produce a modulated pump signal, wherein the modulated pump signal comprises an excitation wavelength;
exciting, with the modulated pump signal, at least one nanoparticle to produce at least one excited nanoparticle;
interacting a probe signal with the at least one excited nanoparticle to produce a measurement signal;
dispersing, spectrally, the measurement signal across a plurality of pixels of a lock-in camera to produce a spectrally dispersed measurement signal; and
detecting, by the lock-in camera, the spectrally dispersed measurement signal.

20. A non-transitory, computer-readable medium, having stored thereon program code that, when executed by a processor, cause the processor to perform operations comprising:
modulating a pump signal according to a modulation frequency to produce a modulated pump signal, wherein the modulated pump signal comprises an excitation wavelength;
exciting, with the modulated pump signal, at least one nanoparticle to produce at least one excited nanoparticle;
interacting a probe signal with the at least one excited nanoparticle to produce a measurement signal;
dispersing, spectrally, the measurement signal across a plurality of pixels of a lock-in camera to produce a spectrally dispersed measurement signal; and
detecting, by the lock-in camera, the spectrally dispersed measurement signal.
